(19) United States
(12) Patent Application Publication
(10) Pub. No.: US 2026/0219875 A1
(43) Pub. Date: Jul. 30, 2026

(54) VEHICLE NETWORK SYSTEM, CONTROL METHOD OF VEHICLE NETWORK SYSTEM AND MANAGER CONTROL DEVICE APPLIED TO VEHICLE NETWORK SYSTEM

(71) Applicant: DENSO CORPORATION, Kariya-city (JP)

(72) Inventors: Sho MATSUMOTO, Kariya-city (JP); Tomohisa KISHIGAMI, Kariya-city (JP)

(21) Appl. No.: 19/427,055

(22) Filed: Dec. 19, 2025

(30) Foreign Application Priority Data
Jan. 28, 2025 (JP) 2025-012469

(51) Int. Cl. G06F 8/656; B60R 16/023

(52) U.S. Cl. CPC G06F 8/656; B60R 16/0231

(57) ABSTRACT

A vehicle network system mounted on a vehicle is provided that includes a management-target control device and a manager control device. The management-target control device retains cluster information indicative of a cluster to which the management-target control device belongs among of clusters, and that becomes an active state in response to an activation message including active-cluster information indicative of the cluster to be active that matches the cluster indicated by the cluster information, The manager control device has a function of configuring the cluster information of the management-target control device based on stored cluster setting information. When receiving for-update cluster setting information from an external device, the manager control device stores the for-update cluster setting information in a storage medium or area separate from a storage medium or area storing the cluster setting information.

### CROSS-REFERENCE OF RELATED APPLICATIONS

This application is based on Japanese Patent Application No. 2025-012469 filed in Japan on Jan. 28, 2025. The entire disclosure of the above application is incorporated herein by reference.

### TECHNICAL FIELD

The present disclosure relates to a vehicle network system including a plurality of control devices communicable with each other, a control method of a vehicle network system, and a manager control device applied to a vehicle network system.

### BACKGROUND

In an in-vehicle system, in-vehicle devices may be classified into multiple clusters on a function basis. A frame (network management message) including designation information indicative of a cluster to be active is used to activate in-vehicle devices that execute a required function while keeping the other in-vehicle devices in a sleep mode. In this way, partial network functionality may be achieved in the in-vehicle system.

### SUMMARY

According to one aspect of the present disclosure, a vehicle network system mounted on a vehicle is provided that includes a management-target control device and a manager control device. The management-target control device retains cluster information indicative of a cluster to which the management-target control device belongs among a plurality of clusters being divisions, and becomes an active state in response to an activation message including active-cluster information indicative of the cluster to be active that matches the cluster indicated by the cluster information. The manager control device includes a storage medium storing cluster setting information for configuring the cluster information of the management-target control device and has a function of configuring the cluster information of the management-target control device based on the stored cluster setting information. When receiving for-update cluster setting information from an external device, the manager control device stores the for-update cluster setting information in a storage medium separate from the storage medium storing the cluster setting information or in a storage area separate from a storage area storing the cluster setting information.

According to another aspect of the present disclosure, a control method of a vehicle network system mounted on a vehicle and including a management-target control device and a manager control device is provided. The management-target control device retains cluster information indicative of a cluster to which the management-target control device belongs among a plurality of clusters being divisions, and becomes an active state in response to an activation message from another control device including active-cluster information indicative of the cluster to be active that matches the cluster indicated by the cluster information. The manager control device includes a storage medium storing cluster setting information for configuring the cluster information of the management-target control device and has a function of configuring the cluster information of the management-target control device based on the stored cluster setting information. The control method includes: when receiving the for-update cluster setting information from an external device, storing the for-update cluster setting information in a storage medium separate from the storage medium storing the cluster setting information or in a storage area separate from a storage area storing the cluster setting information.

According to yet another aspect of the present disclosure, a manager control device applied to a vehicle network system that is mounted on a vehicle and includes a management-target control device and a manager control device is provided. The management-target control device retains cluster information indicative of a cluster to which the management-target control device belongs among a plurality of clusters being divisions, and becomes an active state in response to an activation message including active-cluster information indicative of the cluster to be active that matches the cluster indicated by the cluster information. The manager control device includes a storage medium storing cluster setting information for configuring the cluster information of the management-target control device and has a function of configuring the cluster information of the management-target control device based on the stored cluster setting information. When receiving for-update cluster setting information from an external device, the manager control device stores the for-update cluster setting information in a storage medium separate from the storage medium storing the cluster setting information or in a storage area separate from a storage area storing the cluster setting information.

### BRIEF DESCRIPTION OF DRAWINGS

Objects, features and advantages of the present disclosure will become apparent from the following detailed description made with reference to the accompanying drawings.

FIG. 1 is a diagram illustrating an example configuration of a vehicle network system.

FIG. 2 is a functional block diagram illustrating functions of first to sixth lower-level ECUs with respect to network management.

FIG. 3 is a diagram illustrating an example of an NM message, PN request information, and PNC setting information.

FIG. 4 is a flowchart illustrating an example of a main process routine executable by a high-level ECU when a cluster manager unit is provided in the high-level ECU.

FIG. 5 is a flowchart illustrating an example of a PNC setting necessity determination process at S140 of the flowchart in FIG. 4.

FIG. 6 is a flowchart illustrating an example of a setting status determination process in S350 of the flowchart in FIG. 5.

FIG. 7 is a sequence diagram illustrating an example of a flow of processes at the higher-level ECU and at the first to sixth lower-level ECUs when the setting status determination process is executed.

FIG. 8 is a flowchart illustrating an example of the PNC setting process in S160 of the flowchart in FIG. 4.

FIG. 9 is a sequence diagram illustrating an example of a flow of processes at the higher-level ECU and at the first to sixth lower-level ECUs when the PNC setting process is executed.

FIG. 10 is a flowchart illustrating an example of a PNC setting completion process in S190 of the flowchart in FIG. 4.

FIG. 11 is a diagram illustrating an example of a PNC setting table.

FIG. 12 is a flowchart illustrating an example of a table update process in S210 of the flowchart in FIG. 4.

FIG. 13 is a sequence diagram illustrating an example of a flow of processes at the higher-level ECU and at the first to sixth lower-level ECUs when the table update process is executed.

FIG. 14 is a flowchart illustrating an example of the PNC setting table receiving process in S920 of the flowchart in FIG. 12.

FIG. 15 is a flowchart illustrating an example of the PNC setting table update process.

FIG. 16 is a flowchart illustrating an example of a main process routine executed by each of the first to sixth lower-level ECUs.

FIG. 17 is a flowchart illustrating an example of a PNC setting (for the first time) response process in S1410 of the flowchart in FIG. 16.

FIG. 18 is a flowchart illustrating an example of a PNC setting (for the second time) response process in S1430 of the flowchart in FIG. 16.

FIG. 19 is a flowchart illustrating an example of a setting status check process in S1440 of the flowchart in FIG. 16.

FIG. 20 is a diagram for describing a first example of changing the activation condition according to a first modification.

FIG. 21 is a diagram for describing a second example of changing the activation condition according to the first modification.

FIG. 22 is a flowchart illustrating a setting status check process according to a second modification.

FIG. 23 is a flowchart illustrating a PNC setting (for the first time) response process according to the second modification.

### DETAILED DESCRIPTION

For example, there is an in-vehicle system that includes an in-vehicle device having a communication I/F that supports the partial network function and an in-vehicle device having a communication I/F that does not support the partial network function. In the in-vehicle system, the in-vehicle device having the communication I/F that does not support the partial network function is configured so as to operate according to the partial network function.

Specifically, the operating mode of the in-vehicle device having the communication I/F that does not support the partial network function includes a normal mode, a low clock mode, and a sleep mode. In the sleep mode, a function of the communication I/F to detect the dominant of a communication signal (frame) is executed only, and other functions of the communication I/F are stopped. When the communication I/F detects the dominant of the communication signal, the in-vehicle device switches over from the sleep mode to the low clock mode. In the low clock mode, the communication I/F can perform a frame receiving process but a transmission function remains stopped. In the low-clock mode, an ECU of the in-vehicle device operates at a low clock and can determine whether or not a received frame includes designation information that designates this in-vehicle device as an activation target. If the received frame includes the designation information, the in-vehicle device switches over from the low clock mode to the normal mode.

In the above in-vehicle system, in-vehicle devices are classified into multiple clusters on a function basis. A frame (network management message) including the designation information indicative of a cluster that is to be active is used to activate in-vehicle devices that execute a required function while keeping the other in-vehicle devices in the sleep mode. In this way, the partial network is realized in the in-vehicle system.

In recent years, after vehicle release onto the market, it is possible to update software of ECUs (control device) mounted on the vehicle, by, for example, downloading an application by a vehicle user. In this case, depending on a function of the downloaded application, the ECU may be required to become active not only when an activation condition configured before the update is met but also when another activation condition is met, or the ECU may be required to become active when a different activation condition is met in place of when an activation condition configured before the update is met.

It may be possible to add and change the activation condition by adding or changing a cluster assigned to a respective ECU. Therefore, for example, a vehicle network system may be provided with a manager ECU that can change cluster information of the ECUs via communication with the ECUs mounted on the vehicle. This may provide flexibility in adding and changing the activation condition of each ECU. In the following, the ECU being a target of the activation condition addition and/or change is referred to as a management-target ECU.

For example, it may be possible to change the cluster information of the management-target ECU in the following way. First, an external server may prepare cluster setting information for update including cluster information indicative of the cluster to which each management-target ECU belongs, based on a function of the downloaded application or management-target ECU addition or replacement. A manager ECU may download the cluster setting information for update from the external server. Using the downloaded cluster setting information for update, the manager ECU updates the cluster information retained by each management-target ECU. This makes it possible to add or change a cluster assigned to each management-target ECU, and accordingly, it is possible to add or change an activation condition of each management-target ECU.

However, in a configuration where the manager ECU stores the cluster setting information for update by overwriting the current cluster setting information when downloading the cluster setting information for update, the following difficulty may arise.

For example, if download data is cut off in the middle of downloading due to, for example, a communication failure between the external server and the manager ECU, the current cluster setting information and the cluster setting information for update may coexist. In this case, even if the manager ECU changes the cluster information of each management target ECU based on the updated cluster setting information, the cluster information of each management-target ECU may not necessarily be changed into appropriate cluster information.

It may happen that the current cluster setting information is overwritten with the cluster setting information for update while the manager ECU is changing the cluster information of each management-target ECU based on the current cluster setting information. In this case, the cluster information of part of the management-target ECUs may become different from the cluster information in the cluster setting information for update.

The present disclosure is made in view of the foregoing, and has an object to provide a vehicle network system, a control method of a vehicle network system, and a manager control device applied to a vehicle network system in which it is possible for a manager control device to receive for-update cluster setting information from an outside and to appropriately store the received for-update cluster information.

According to a first aspect, a vehicle network system mounted on a vehicle and comprising a plurality of control devices communicable with each other is provided. The plurality of control devices includes: a management-target control device that retains cluster information indicative of a cluster to which the management-target control device belongs among a plurality of clusters being divisions, and that becomes an active state in response to an activation message from another control device including active-cluster information indicative of the cluster to be active that matches the cluster indicated by the cluster information; and a manager control device that includes a storage medium storing cluster setting information for configuring the cluster information of the management-target control device and has a function of configuring the cluster information of the management-target control device based on the stored cluster setting information. The manager control device is capable of receiving, from an external device, for-update cluster setting information for updating the cluster setting information. When receiving the for-update cluster setting information, the manager control device stores the for-update cluster setting information in a storage medium separate from the storage medium storing the cluster setting information or in a storage area separate from a storage area storing the cluster setting information.

According to a second aspect, a control method of a vehicle network system mounted on a vehicle and including a plurality of control devices communicable with each other is provided. The plurality of control devices includes: a management-target control device that retains cluster information indicative of a cluster to which the management-target control device belongs among a plurality of clusters being divisions, and that becomes an active state in response to an activation message from another control device including active-cluster information indicative of the cluster to be active that matches the cluster indicated by the cluster information; and a manager control device that includes a storage medium storing cluster setting information for configuring the cluster information of the management-target control device and has a function of configuring the cluster information of the management-target control device based on the stored cluster setting information. The control method comprises: the manager control device receiving, from an external device, for-update cluster setting information for updating the cluster setting information; and when receiving the for-update cluster setting information, the manager control device storing the for-update cluster setting information in a storage medium separate from the storage medium storing the cluster setting information or in a storage area separate from a storage area storing the cluster setting information.

According to a third aspect, a manager control device applied to a vehicle network system that is mounted on a vehicle and includes a plurality of control devices communicable with each other is provided. The plurality of control devices includes: a management-target control device that retains cluster information indicative of a cluster to which the management-target control device belongs among a plurality of clusters being divisions, and that becomes an active state in response to an activation message from another control device including active-cluster information indicative of the cluster to be active that matches the cluster indicated by the cluster information; and the manager control device that includes a storage medium storing cluster setting information for configuring the cluster information of the management-target control device and has a function of configuring the cluster information of the management-target control device based on the stored cluster setting information. The manager control device is capable of receiving, from an external device, for-update cluster setting information for updating the cluster setting information. When receiving the for-update cluster setting information, the manager control device stores the for-update cluster setting information in a storage medium separate from the storage medium storing the cluster setting information or in a storage area separate from a storage area storing the cluster setting information.

In the vehicle network system, the control method of the vehicle network system, and the manager control device applied to the vehicle network system according to the present disclosure: the plurality of control devices includes the manager control device having the function of configuring the cluster information of the management-target control device based on the stored cluster setting information. Therefore, it is possible to provide flexibility regarding adding and/or changing activation condition of the management-target control device.

Furthermore, in the vehicle network system, the control method of the vehicle network system, and the manager control device applied to the vehicle network system according to the present disclosure: when receiving the for-update cluster setting information, the manager control device stores the for-update cluster setting information in a storage medium separate from the storage medium storing the cluster setting information or in a storage area separate from a storage area storing the cluster setting information. Therefore, it is possible to avoid co-exist of the cluster setting information and the for-update cluster setting information even if download data is cut off. Furthermore, even if the for-update cluster setting information is received while the cluster information of each management-target ECU is being changed based on the cluster setting information, it is possible to configure the cluster information of each management-target ECU consistently.

Embodiments of a vehicle network system, a control method of a vehicle network system and a manager control device applied to a vehicle network system in accordance with the present disclosure will be described with reference to the drawings. The present disclosure is not limited to the following embodiments, and various modifications described below are also included in the technical scope of the present disclosure. In addition to the following embodiments, various modifications can be made without departing from the spirit and scope of the present disclosure. The embodiments and various modifications can be combined to extent that does not cause technical inconsistency. In the following description, the same or similar components may be denoted by the same or similar reference symbols throughout the drawings, and descriptions thereof may be omitted. In addition, in a case where only part of the configuration is referred to in an embodiment or modification example, the description in the foregoing embodiment may be applied to the rest of the configuration.

### First Embodiment

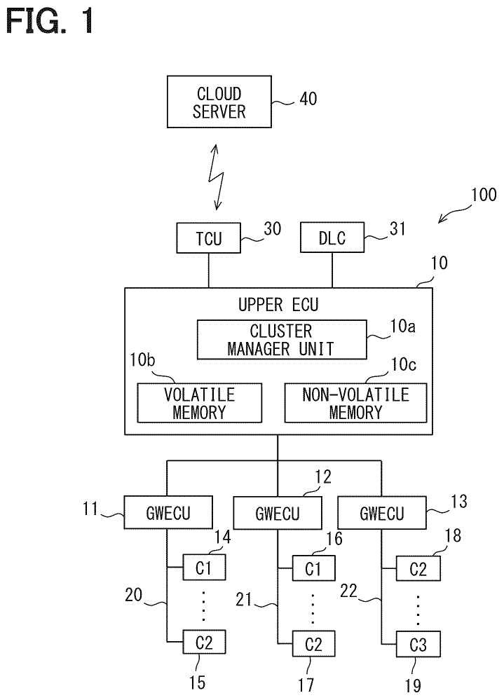

FIG. 1 shows an example configuration of a vehicle network system 100 according to the present embodiment. As shown in FIG. 1, the vehicle network system 100 includes a higher-level ECU 10, first to third GW ECUs 11 to 13, and first to sixth lower-level ECUs 14 to 19 communicable with each other via a network. ECU is an abbreviation for Electronic Control Unit. GW is an abbreviation for Gate Way. In the present embodiment, the upper-level ECU 10, the first to third GW ECUs 11 to 13, and the first to sixth lower-level ECUs 14 to 19 are mounted on a vehicle. Examples of vehicle include a passenger car, a motorcycle, a transport vehicle, a construction vehicle, and an agricultural vehicle.

The higher-level ECU 10 may, for example, function as a domain controller that supervises controls of the first to sixth lower-level ECUs 14 to 19. Domains refers to units of function when vehicle functions are broadly divided into, for example, a powertrain domain, a chassis domain, an advanced driver assistance domain, a body domain, a cockpit domain, and the like. For example, when the domain controller of the powertrain domain is the higher-level ECU 10, the first to sixth lower-level ECUs 14 to 19 include various ECUs for controlling the vehicle's powertrain, such as an engine ECU, a motor (or inverter) ECU, a battery monitoring ECU, and a transmission ECU. When the controller of the chassis domain is the higher-level ECU 10, the first to sixth lower-level ECUs 14 to 19 include various ECUs for chassis control of the vehicle, such as a steering ECU, a brake ECU, and a suspension ECU.

The above is an example of how to divide into the domains, and the domains may be different from the above-described example. The higher-level ECU 10 may be a central ECU which supervises controls of the first to sixth lower-level ECUs 14 to 19 located in areas of the vehicle. In this case, the first to third GW ECU 11 to 13 is located in a respective area together with the first to sixth lower-level ECUs 14 to 19. Furthermore, although FIG. 1 shows an example of the vehicle network system 100 with one higher-level ECU 10, the vehicle network system 100 may include multiple higher-level ECUs. In this case, multiple higher-level ECUs may be connected communicably with each other. GW ECUs and lower-level ECUs may be located as subordinates of a respective higher-level ECU.

The higher-level ECU 10 includes a cluster manager unit 10a, as a manager control device. The cluster manager unit 10a performs management by linking the first to sixth lower-level ECUs 14 to 19, which are all of the lower-level ECUs connected to the network (corresponding to management-target control devices in the present disclosure), to their respective cluster information (hereinafter referred to as PNC setting information). More specifically, the cluster manager unit 10a is configured to recognize the link between each of the first to sixth lower-level ECU 14 to 19 and its PNC setting information by a PNC setting table (corresponding to cluster setting information of the present disclosure). The PNC setting table is stored in a non-volatile memory 10c of the upper-level ECU 10. Because of this, for all of the first to sixth lower-level ECUs 14, the cluster manager unit 10a can manage to which cluster a respective lower-level ECUs 14 to 19 belongs and to which cluster the respective lower-level ECUs 14 to 19 does not belong, based on the PNC setting information linked to the first to sixth lower-level ECUs 14 to 19 in the PNC setting table. The PNC setting information and the PNC setting table will be described in detail later. PNC is an abbreviation for Partial Network Clustering.

Furthermore, the cluster manager unit 10a of the higher-level ECU 10 has a function of changing the PNC setting information of all of the first to sixth lower-level ECUs 14 to 19 connected to the network. Changing the PNC setting information may be rephrased as configuring the PNC setting information, setting the PNC setting information, reconfiguring the PNC setting information, setting again the PNC setting information, or updating the PNC setting information. For example, when there arises a necessity to change the PNC setting information of at least one of the first to sixth lower-level ECUs 14 to 19 due to addition or replacement of the first to sixth lower-level ECU 14 to 19 or addition of an application, the cluster manager unit 10a appropriately changes the PNC setting information of the firs to sixth lower-level ECUs 14 to 19 based on an updated PNC setting table. In this case, the cluster manager unit 10a may configure (reconfigure) the PNC setting information only for the lower-level ECU to which the change in the PNC setting information is made. The cluster manager unit 10a may determine whether or not the PNC setting information in the PNC setting table matches the PNC setting information retained by the first to sixth lower-level ECUs 14 to 19. Upon determining the PNC setting information in the PNC setting table does not match the PNC setting information retained by the first to sixth lower-level ECUs 14 to 19, the cluster manager unit 10a may configure (reconfigure) the PNC setting information retained by the first to sixth lower ECUs 14-19 based on the PNC setting information in the PNC setting table. Furthermore, upon receipt of a message requesting to configure the PNC setting information from at least one of the first to sixth lower-level ECUs 14 to 19, the cluster manager unit 10a may configure (reconfigure) the PNC setting information retained by the first to sixth lower-level ECUs 14 to 19 based on the PNC setting information in the PNC setting table.

The wakeup condition (activation condition) of the first to sixth lower-level ECU 14 to 19 is changeable via the PNC setting information. Therefore, for example, a cloud server 40 prepares, on an as-needed basis, a PNC setting table in which a change is made to the PNC setting information already applied to at least one lower-level ECU that executes the downloaded application.

For example, assume a vehicle includes a camera and the camera is used during vehicle traveling for an advanced driver assistance function, such as lane keep assist and obstacle detection. A vehicle user may download an application for providing a monitoring function of monitoring environments around the vehicle and home using the camera during parked. In this case, the camera is required to operate not only when the vehicle is traveling, but also when the vehicle is parked. In this case, the lower-level ECU for controlling the camera is required to be in the wakeup mode (active state) when the vehicle is parked, in addition to when the vehicle is traveling. In such a case, for example, the cloud server 40 may prepare the PNC setting table in which a cluster for a group of ECUs necessary for controlling the camera when the vehicle is in the parked state is added.

As described, in cases of addition or replacement of the first to sixth lower-level ECUs 14 to 19 or addition of an application for example, the PNC setting table including the post-change PNC setting information (corresponding to cluster setting information for update also called for-update cluster setting information of the present disclosure) may be prepared by the cloud server 40. The cluster manager unit 10a may acquire the PNC setting table update information by communication with the cloud server 40 via a TCU 30. The acquired PNC setting table update information is saved in a volatile memory 10b being a temporary storage. Then, the cluster manager unit 10a performs a PNC setting table update process described below to update the PNC setting table stored in the non-volatile memory 10c based on the PNC setting table of the acquired PNC setting table update information. TCU is an abbreviation for Telematics Control Unit. The PNC setting table update information may be acquired, for example, from a data device (not shown in the drawings) connected to the DLC 31. DLC is an abbreviation for Data Link Coupler.

A function of a manager control device may be realized not only by the upper-level ECU 10, but also by coordination of multiple ECUs. For example, an ECU other than the upper-level ECU 10 may receive the PNC setting table update information from the cloud server 40 and save the PNC setting table update information in a temporary storage. Then, the ECU that saved the PNC setting table update information in the temporary storage may cooperate with the upper-level ECU 10 to update the PNC setting table stored in the non-volatile memory 10c of the upper-level ECU 10.

Furthermore, from the cloud server 40 via the TCU 30, the higher-level ECU 10 may download an application for providing a new function in the vehicle and/or an update program for upgrading a program already implemented in at least one of the lower-level ECUs 14 to 19. The higher-level ECU 10 may provide the application and the update program to the appropriate lower-level ECU 14 to 19. Alternatively, the higher-level ECU 10 may acquire the application and/or the update program from the data device, not shown, via the DLC 31.

FIG. 1 shows a configuration in which the higher-level ECU 10 includes the cluster manager unit 10a which performs managing and changing the PNC setting information of the first to sixth lower-level ECUs 14 to 19. However, the cluster manager unit 10a may be provided in an ECU other than the higher-level ECU 10, as long as the cluster manager unit 10a is communicable with all of the first to sixth lower-level ECUs 14 to 19 connected to the network. For example, the cluster manager unit 10a may be provided in any of the first or third GW ECUs 11 to 13. It should be noted, however, that only one cluster manager unit 10a is provided in the vehicle network system 100. This is because if multiple cluster manager units 10a are provided in the vehicle network system 100, the PNC setting information in the first to sixth lower-level ECUs 14 to 19 may conflict, causing a defect in setting of the PNC setting information.

The first to third GW ECUs 11 to 13 serve as relay devices in the network, for example, for bidirectional communication between the first to sixth lower-level ECUs 14 to 19 connected to different communication buses 20 to 22. The first to third GW ECUs 11 to 13 are arranged between the higher-level ECU 10 and the first to sixth lower-level ECUs 14 to 19 and may therefore be called middle-level ECUs. The first to third GW ECU 11 to 13 has a sleep mode and a wakeup mode. In the sleep mode, the first to third GW ECU 11 to 13 executes a function to receive the network management message (“NM message”) and stop other functions. Specifically, the first to third GW ECU 11 to 13 includes a communication IF that supports the partial network function.

The first to third GW ECU 11 to 13 in the sleep mode transitions to the wakeup mode upon receipt of an NM message to wake up the subordinate which is the first to sixth lower-level ECU 14 to 19 or upon receipt of an NM message transmitted from the subordinate which is the first to sixth lower-level ECU 14 to 19 from any of the connected communication buses 20 to 22. In the wakeup mode, the first to third GW ECU 11 to 13 can execute all functions. For example, the first to third GW ECU 11 to 13 can execute the function of gatewaying (relaying) an NM message received from one communication bus 20 to 22 to another communication bus 20 to 22. Between the first to sixth lower-level ECUs 14 to 19, control messages including data and other information related to controls are exchanged in addition to the NM messages for realizing the partial network. The first to third GW ECU 11 to 13 in the wakeup mode can also execute gatewaying the control messages.

Each first to third GW ECU 11 to 13 maintains the wakeup mode when one of the first to sixth lower-level ECUs 14 to 19 being subordinates thereof is in the wakeup mode. In other words, each first to third GW ECU 11 to 13 transitions to the sleep mode after all of the first to sixth lower-level ECUs 14 to 19 being subordinates thereof transitions to the sleep mode.

In the example shown in FIG. 1, the first and second lower-level ECUs 14 and 15 are connected via a communication bus 20 to the first GW ECU 11 as the subordinates of the first GW ECU 11. The third and fourth lower-level ECUs 16 and 17 are connected via a communication bus 21 to the second GW ECU 12 as the subordinates of the second GW ECU 12. Furthermore, the fifth and sixth lower-level ECUs 18 and 19 are connected via a communication bus 22 to the third GW ECU 13 as the subordinates of the third GW ECU 13. The number of lower-level ECUs 14 to 19 connected to a respective communication bus 20 to 22 is not limited to two and may be one, or three or more. Furthermore, a single GW ECU 11 to 13 may be connected to multiple communication buses each connected to the lower-level ECUs being the subordinate of the single GW ECU 11 to 13.

Examples of the first to six lower-level ECU 14 to 19 include a control ECU that executes a control process for controlling a given control target in the vehicle, a sensor ECU that executes calculation process of calculating a given physical quantity based on a detection signal detected by a sensor, or a drive ECU that executes a drive process of outputting a drive signal to an actuator to drive the actuator. The first to sixth lower-level ECU 14 to 19, like the first to third GW ECUs 11 to 13, includes a communication IF that supports the partial network function. When the first to sixth lower-level ECU 14 to 19 needs to control a control object, calculate a given physical quantity based on a sensor detection signal, or drive an actuator, the first to sixth lower-level ECU 14 to 19 transitions to the wakeup mode and executes the given control process, the calculation process, or the drive process. When the first to sixth lower-level ECU 14 to 19 does not need to perform the given control process, the calculation process, nor the drive process, the first to sixth lower-level ECU 14 to 19 transitions to the sleep mode, which is a sleep state in which the functions other than receiving NM messages are stopped.

To switch over between the wakeup mode and the sleep mode, a respective first to sixth lower-level ECU 14 to 19 has the PNC setting information indicative of the cluster to which this respective first to sixth lower-level ECU 14 to 19 belongs among the multiple clusters being multiple divisions. The PNC setting information is information for grouping multiple lower-level ECUs 14 to 19 into a group of ECUs required to wake up at the same time period to provide at least one desired function in the vehicle.

While executing the given control process or the calculation process, a respective first to sixth lower-level ECU 14 to 19 in the wakeup mode periodically transmits the NM message including active-cluster information (also called PN request information) in which the cluster to which this respective lower-level ECU belong is designated as the active cluster. Further, when a respective first to sixth lower-level ECUs 14 to 19 receives the NM message including the PN request information in which the cluster to which this respective lower-level ECU belong is designated as the active cluster, this respective lower-level ECU wakes up from the sleep mode if in the sleep mode and keeps the wakeup mode if in the wakeup mode. This causes two or more lower-level ECUs belonging to the same cluster to be in the wakeup mode at the same time period, so that coordinated control by the two or more lower-level ECUs can be executed smoothly.

The first to sixth lower-level ECU 14 to 19 in the wakeup mode stops transmitting the NM message upon completing execution of the given control process, the calculation process, or the drive process. A respective first to sixth lower-level ECU 14 to 19 transitions to the sleep mode upon elapse of a given time during which the NM message including the PN request information in which the cluster to which this lower-level ECU belong is designated as the active cluster is not received by this lower-level ECU (upon elapse of the given time since the last time the NM message was received). As a result, the first to sixth lower-level ECUs 14 to 19 that belongs to the same cluster transitions from the wakeup mode to the sleep mode at approximately the same time. In this way, only necessary ECUs can be woken up in units of cluster, and the partial networking is realized. By the partial networking, only those ECUs that are required to operate can be placed in the wakeup mode, reducing power consumption of each ECU in the vehicle.

The higher-level ECU 10 may include a function of generating and transmitting NM messages to control the switch over of the first to sixth lower-level ECUs 14 to 19 between the wakeup mode and the sleep mode in units of cluster. For example, the higher-level ECU 10 determines a function to be executed in the vehicle, based on the state of the vehicle (e.g., travelling, stopped, parked, etc., and/or the state of operation of various vehicle functions by the user) ascertained from information acquired from a sensor, a switch, and/or another ECU. Upon determining that a desired function needs to be executed, the higher-level ECU 10 generates and transmits the NM message including the PN request information in which the cluster to which the first to sixth lower-level ECUs 14 to 19 required to be in the wakeup mode at the same time for execution of the desired function belong is designated as the active cluster. This causes the desired function to be executed by the lower-level ECUs 14 to 19 woken up by the NM message.

In addition to or in place of the higher-level ECU 10, the function of determining the function to be executed in the vehicle and transmitting the NM message including the PN request information may be provided in the first to third GW ECU 11 to 13 and/or the first to sixth lower-level ECU 14 to 19. Furthermore, when the vehicle includes multiple higher-level ECUs and multiple lower-level ECUs arranged as subordinates of each higher-level ECU, the NM message may be transmitted from another higher-level ECU or a lower-level ECU arranged as a subordinate of another higher-level ECU.

The vehicle network system 100 may use CAN (registered trademark) as a communication protocol for the higher-level ECU 10, the first to third GW ECUs 11 to 13, and the first to sixth lower-level ECUs 14 to 19 to communicate with each other. CAN is an abbreviation for Controller Area Network. The communication protocol is not limited to CAN. The in-vehicle network system 100 can employ various communication protocols such as Ethernet (registered trademark), LIN (Local Interconnect Network), FlexRay (registered trademark), and CAN-FD (CAN with Flexible Data Rate). For example, different communication protocols may be employed for different communication buses, including a communication bus between the higher-level ECU 10 and the first to third GW ECU 11 to 13, and a communication bus between the first to third GW ECU 11 to 13 and the first to sixth lower-level ECU 14 to 19. In the present embodiment, the vehicle network system 100 is configured so that for each group (i.e., cluster) including at least one lower-level ECU 14 to 19, what is called network management is feasible in which the operating mode of the lower-level ECU 14 to 19 is switched over between the wakeup mode and the sleep mode. Therefore, the communication protocol employed in the vehicle network system 100 is required to support the network management.

The higher-level ECU 10, the first to third GW ECUs 11 to 13, and the first to sixth lower-level ECUs 14 to 19 may each include a computer including a processor, a memory, and a storage. Examples of the processor include a CPU (Central Processing Unit), an MPU (Micro Processing Unit), a GPU (Graphics Processing Unit), and a DFP (Data Flow Processor), which are capable of executing a given process according to a program. The memory is a volatile storage medium, such as a RAM (Random Access Memory), which temporarily stores a result of calculation process executed by the processor. The storage includes a rewritable non-volatile storage medium, e.g., flash memory, read only memory (ROM). The storage stores various data and programs executed by the processor. Part or all of the functions provided by the higher-level ECU 10, the first to third GW ECUs 11 to 13, and the first to sixth lower-level ECU 14 to 19 may be provided by hardware using, for example, an ASIC (Application Specific Integrated Circuit) or FPGA (Field Programmable Gate Array (FPGA), for example. FIG. 1 shows the cluster manager unit 10a, which is a functional unit provided in the higher-level ECU 10 by software and/or hardware.

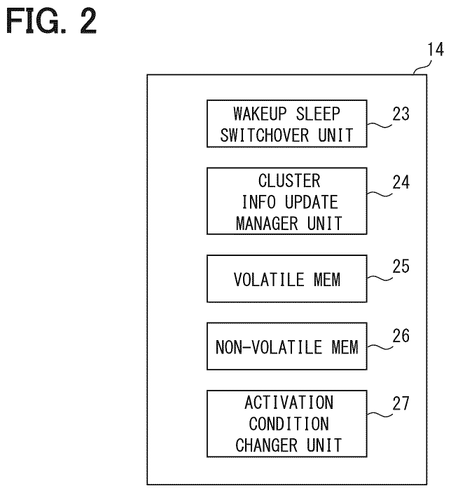

The first to sixth lower-level ECUs 14 to 19 may each be similarly configured. FIG. 2 shows a block diagram of the functions provided by the first to sixth lower-level ECU 14 to 19 with respect to the network management. FIG. 2 depicts the first lower-level ECU 14 as a representative example. As shown in FIG. 2, the first lower-level ECU 14 includes a wakeup sleep switchover unit 23, a cluster information update manager unit 24, a volatile memory 25, a non-volatile memory 26, and an activation condition changer unit 27.

The wakeup sleep switchover unit 23 may be provided primarily by the communication IF that supports the partial network function. The wakeup sleep switchover unit 23 switches over the first lower-level ECU 14 into the sleep mode upon, in the sleep mode, receipt of the NM message including the PN request information in which the cluster to which the first lower-level ECU 14 belongs is designated as the active cluster. Conversely, the wakeup sleep switchover unit 23 switches over the first lower-level ECU 14 into the wakeup mode upon, in the wakeup mode, elapse of the given time during which the NM message including the PN request information in which the cluster to which the first lower-level ECU 14 belongs is designated as the active cluster is not received by the first lower-level ECU 14 (elapse of the given time since the last time the NM message was received).

The first to sixth lower-level ECU 14 to 19 may not have the communication IF that supports the partial network function. In this case, upon receipt of the NM message in the sleep mode, the wakeup sleep switchover unit 23 wakes up the first lower-level ECU 14 once, regardless of whether or not the wakeup of the first lower-level ECU 14 is indicated in the NM message. The wakeup sleep switchover unit 23 then uses a processing function of the woken-up first lower-level ECU 14 to determine whether the NM message includes the active-cluster information in which the cluster to which the first lower-level ECU 14 belongs is designated as the active cluster. Upon determining that the NM message includes the PN request information that designates the cluster to which the first lower-level ECU 14 belongs as the active cluster, the wakeup sleep switchover unit 23 maintains the wakeup state of the first lower-level ECU 14. Upon determining that the NM message does not include the PN request information that designates the cluster to which the first lower-level ECU 14 belongs as the active cluster, the wakeup sleep switchover unit 23 puts the first lower-level ECU 14 into the sleep mode again.

In response to receiving a PNC setting information check request (also called a PNC setting value check request) message from the cluster manager unit 10a of the higher-level ECU 10, the cluster information update manager unit 24 reads the values (PNC setting values) of the PNC setting information stored in the non-volatile memory 26 and transmits the read values to the cluster manager unit 10a as a response. The cluster information update manager unit 24 executes the PNC setting information update process to update the PNC setting information stored in the non-volatile memory 26 in response to receiving a PNC setting information setting request (also called a PNC setting request) message from the cluster manager unit 10a.

In the PNC setting information update process, the cluster information update manager unit 24 first receives the post-change PNC setting information included in the PNC setting request message transmitted from the cluster manager unit 10a and stores the post-change PNC setting information in the volatile memory 25 once. Next, the cluster information update manager unit 24 checks whether the post-change PNC setting information stored in the volatile memory 25 and the current PNC setting information stored in the non-volatile memory 26 perfectly match each other. If the check result is a perfect match, the cluster information update manager unit 24 does not execute a process of writing the PNC setting information stored in the volatile memory 25 into the non-volatile memory 26. If the check result is not the perfect match, the cluster information update manager unit 24 executes the process of writing the PNC setting information stored in the volatile memory 25 into the non-volatile memory 26, thereby updating the PNC setting information stored in the non-volatile memory 26. Writing the PNC setting information into the non-volatile memory 26 may be overwriting the PNC setting information stored in the non-volatile memory 26 or writing into a different storage area. The cluster information update manager unit 24 writes the PNC setting information into the different storage area so that it is possible to identify which PNC setting information is the latest.

The cluster information update process described above includes writing the PNC setting information into the non-volatile memory 26 only when the PNC setting information stored in non-volatile memory 26 does not completely match the PNC setting information stored in the volatile memory 25. In typical, the non-volatile memory 26 has an upper limit on the number of rewrites, and when the number of rewrites reaches the limit, it is necessary to replace the non-volatile memory 26. According to the present embodiment, the number of times the non-volatile memory 26 is rewritten due to the PNC setting information update process can be reduced. Thus, it is possible to effectively prevent the number of rewrites of the non-volatile memory 26 from reaching the upper limit.

When the PNC setting information of the first lower-level ECU 14 is changed by the cluster manager unit 10a of the higher-level ECU 10, the activation condition changer unit 27 determines whether or not the changed PNC setting information is appropriate. Upon determining that the changed PNC setting information is not appropriate, the activation condition changer unit 27 changes the activation condition of the first lower-level ECU 14. For example, if the post-change PNC setting information indicates that the first lower-level ECU 14 does not belong to any of the clusters, the activation condition changer unit 27 may determine that the PNC setting information is not appropriate.

If change in the PNC setting information by the cluster manager unit 10a is not complete, the activation condition changer unit 27 may also determine that the PNC setting information is not appropriate. In a case of a large number of clusters, there may be a case where the cluster manager unit 10a cannot include the post-change PNC setting information in a single PNC setting request message. In this case, the cluster manager unit 10a divides the post-change PNC setting information into multiple pieces and transmits multiple PNC setting request messages respectively including the divided pieces of the post-change PNC setting information. In this case, if a communication failure occurs for some reasons before the transmission of all of the PNC setting request messages including the post-change PNC setting information is completed, it may happen that the change in the PNC setting information by the cluster manager unit 10a was started but is incomplete. In the present embodiment, the activation condition changer unit 27 has the function of determining whether or not the change in the PNC setting information is incomplete. Upon determining that the change in the PNC setting information is not complete, the activation condition changer unit 27 may determine that the PNC setting information is not appropriate.

Upon determining that the PNC setting information is not appropriate, the activation condition changer unit 27 changes the activation condition of the first lower-level ECU 14. For example, as the change in the activation condition, the activation condition changer unit 27 may change the PNC setting values in the PNC setting information so that the first lower-level ECU 14 belongs to all of the clusters. This allows the first lower-level ECU 14 to be woken up by any NM message including the PN request information that designates at least one cluster as the active cluster. It is therefore possible to prevent an occurrence of such difficulties that the first lower-level ECU 14 to be woken up for providing a required function is not woken up and that the NM message cannot wake up the first lower-level ECU 14.

This reception timer is used to measure the time elapsed since the PNC setting value check request was transmitted from the higher-level ECU 10. As mentioned above, if the first lower-level ECU 14 wakes up by any NM message, the first lower-level ECU 14 wakes up other than when the first lower-level ECU 14 is required to wake up. In view of this, it may be preferable to reconfigure the PNC setting information of the first lower-level ECU 14 to the appropriate PNC setting information in order to reduce power consumption.

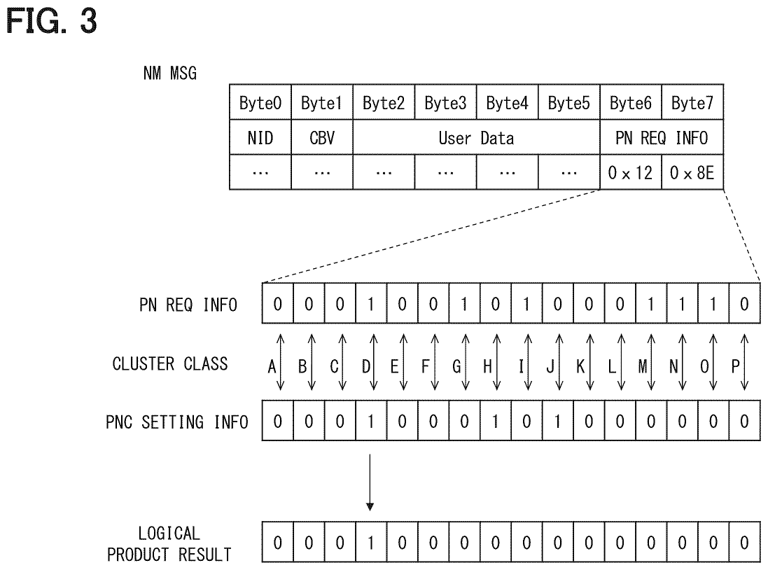

Next, with reference to FIG. 3, examples of the NM message, the PN request information and the PNC setting information will be described in detail.

The NM message, for example, includes data from Byte0 to Byte7, as shown in FIG. 3. Byte0 includes a node ID (i.e., NID). The node ID is an identifier unique to each of the higher-level ECU 10, the first to third GW ECUs 11 to 13, and the first to sixth lower-level ECUs 14 to 19. Via the node ID, a transmission source of the NM message is identifiable. Byte1 includes a control bit vector (CBV). The control bit vector includes data indicating whether or not the partial networking is used. When the data in the control bit vector indicates use of the partial networking, the user data area of Byte2 to Byte7 includes the PN request information being the active-cluster information indicating the cluster to be active.

In the example shown in FIG. 3, the control bit vector indicates use of partial networking and the PN request information is stored in Byte6 and Byte7 of the user data area. The user data area of Byte2 to Byte5 is usable to transmit any information such as an activation factor of ECU or information regarding normality or abnormality, for example. FIG. 3 merely shows one example of the format of the NM message, and the NM message may be in another format as long as the NM message includes the PN request information. For example, NID and CBV may be omitted.

For each of the clusters being multiple divisions, the PN request information indicates an active cluster to be active and a cluster not required to be active. More specifically, in the example shown in FIG. 3, the clusters given by dividing in advance are 16 clusters. The PN request information includes 16-bit data respectively corresponding to the 16 clusters. That is, the 16-bit data of the PN request information is associated with the 16 clusters being divisions in advance. When a certain bit in the 16-bit data of the PN request information is “0”, this indicates that the activation of the cluster associated with this certain bit is not required. This is true for each bit in the 16-bit data. When a certain bit in the 16-bit data of the PN request information is “1”, the data indicates that the activation of the cluster associated with this certain bit is required. This is true for each bit in the 16-bit data. The PN request information may indicate only the cluster to be active. Alternatively, the PN request information may indicate only the cluster that is not required to be active.

As described above, an ECU, which may be at least the first to sixth lower-level ECU 14 to 19, retains the PNC setting information which indicates the cluster to which this ECU belong among the multiple clusters being the multiple divisions. More specifically, the PNC setting information of each lower-level ECU 14 to 19 is stored in the non-volatile memory 26. An example of the PNC setting information is shown in FIG. 3. When, in the PNC setting information shown in FIG. 2, the associated clusters are classified as clusters A to P from the left to the right of FIG. 3, the PNC setting information in FIG. 3 indicates that the lower-level ECU having this PNC setting information belongs to the clusters D, H, and J. Since the first to sixth lower-level ECU 14 to 19 is capable of performing various functions by executing programs or the like, the first to sixth lower-level ECU 14 to 19 may belong to one or more clusters.

The first to sixth lower-level ECUs 14 to 19 can receive NM messages including the PN request information by their respective communication IFs. Upon receiving the NM message, the first to sixth lower-level ECU 14 to 19 compares, bit by bit, between the PN request information and the PNC setting information and for example, calculates logical products, as shown in FIG. 3. In other words, a respective first to sixth lower-level ECU 14 to 19 determines whether the active cluster which is requested to be active by the PN request information included in the NM message matches the cluster in the PNC setting information assigned to the respective first to sixth lower-level ECU 14 to 19. For example, in the example shown in FIG. 3, the active cluster which is requested to be active by the PN request information included in the NM message is the clusters D, G, I, M, N, and O. The cluster to which the lower-level ECU belongs, indicated by the PNC setting information, is the clusters D, H, and J. In this case, at the cluster D, there is a match between the active cluster requested to be active by the PN request information included in the NM message and the cluster of the PNC setting information. Therefore, the calculation result of logical products includes “1” at the cluster D, as shown in FIG. 3.

When the result of logical products is the presence of “1” at one or more bits, the ECU having the PNC setting information shown in FIG. 3 determines that the activation is requested. In response to this determination result, the lower-level ECU having the PNC setting information shown in FIG. 3 transitions from the sleep mode to the wakeup mode, or maintains the wakeup mode if already in the wakeup mode. When the result of logical products is that no bits are “1” and all of the bits are “0”, the ECU having the PNC setting information shown in FIG. 3 determines that the activation is not requested. In this case, the communication I/F of the lower-level ECU having the PNC setting information shown in FIG. 3 discards the received NM message. A method of determining whether or not there is a cluster match between the PN request information and the PNC setting information is not limited to a method of calculating logical products.

As described, a respective first to sixth lower-level ECU 14 to 19 has the function of identifying whether or not the NM message is a request to activate this first to sixth lower-level ECU based on the PNC setting information thereof. With this function of identifying the NM message, the NM message wakes up only the first to sixth lower-level ECU 14 to 19 that has the PNC setting information that includes the cluster of which the activation is requested by the PN request information.

For example, FIG. 1 shows an example where the first and third lower-level ECUs 14 and 16 are grouped into the cluster C1, the second, fourth, and fifth lower-level ECUs 15, 17, and 18 are grouped into the cluster C2, and the sixth lower-level ECU 19 is grouped into the cluster C3. Thus, for example, when the higher-level ECU 10 transmits the NM message including the PN request information that designates the cluster C1 as the active cluster requested be active, the NM message causes the first and third lower-level ECUs 14 and 16 to become the wakeup mode, while the other lower-level ECUs 15, 17 to 19 remain in the sleep mode, realizing the partial networking.

In addition to the first to sixth lower-level ECUs 14 to 19, the PNC setting information may be set for each of the higher-level ECU 10 and/or the first to third GW ECUs 11 to 13 so as to wake up and sleep by NM messages.

Next, the details of the processes executed in each of the higher-level ECU 10 and the first to sixth ECUs 14 to 19 for the network management including realization of the partial networking in the vehicle network system 100 of the present embodiment will be described with reference to flowcharts and sequence diagrams. Execution of the processes shown in the flowcharts described below by the higher-level ECU 10 and the first to sixth ECUs 14 to 19 corresponds to execution of the control method of the vehicle network system 100 in the present disclosure.

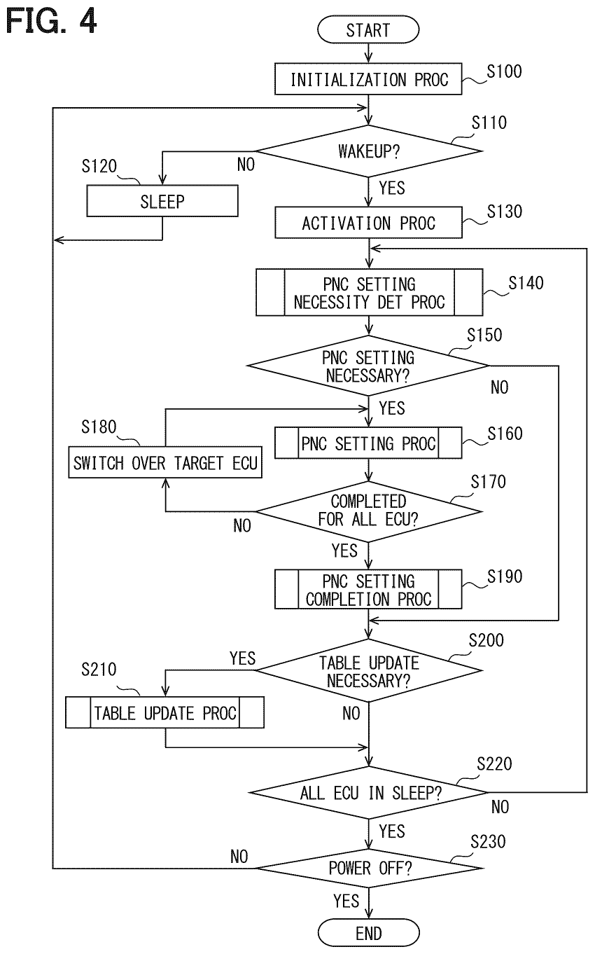

The flowchart of FIG. 4 shows an example of a main process routine that may be executed in the higher-level ECU 10 when the cluster manager unit 10a is provided in the higher-level ECU 10. Upon power on, the higher-level ECU 10 starts the main process routine shown in the flowchart in FIG. 4.

In step S100, the higher-level ECU 10 executes an initialization process. The initialization process includes, for example, hardware initial setting and storage medium operation checking. In step S110, the higher-level ECU 10 determines whether or not a wakeup factor for the higher-level ECU 10 has occurred. For example, the higher-level ECU 10 may determine that the wakeup factor has occurred, upon input of a signal indicative of necessity to wakeup (trigger signal, switch signal, sensor signal, etc.), or upon receipt of the NM message including the PN request information in which the cluster to which the higher-level ECU 10 belongs is designated as the active cluster. Upon determining in step S110 that the wakeup factor has not occurred, the higher-level ECU 10 proceeds to step S120 and transitions to the sleep mode. Upon determining that the wakeup factor has occurred, the higher-level ECU 10 proceeds to step S130.

In step S130, the higher-level ECU 10 executes an activation process. The activation process includes, for example, reading software including an operating system (OS) and a program from the storage and storing the read software in the memory. In step S140, the higher-level ECU 10 executes the PNC setting necessity determination process to determine whether or not it is necessary to set the PNC setting information to the first to sixth lower-level ECUs 14 to 19. Setting the PNC setting information may be rephrased as configuring the PNC setting information. The PNC setting necessity determination process will be described in detail later.

In step S150, the higher-level ECU 10 determines, based on a result of the PNC setting necessity determination process of step S140, more specifically, based on a value of a PNC setting flag which is set in the PNC setting necessity determination process, whether or not it is necessary to set the PNC setting information of the first to sixth lower-level ECUs 14 to 19. Upon determining that it is necessary to set the PNC setting information, the higher-level ECU 10 proceeds to step S160. Upon determining that it is not necessary to set the PNC setting information, the higher-level ECU 10 proceeds to step S200.

In step S160, the higher-level ECU 10 executes the PNC setting process to reconfigure the PNC setting information of the first to sixth lower-level ECUs 14 to 19. The PNC setting process will be described in detail later. In step S170, the higher-level ECU 10 determines whether or not the PNC setting process is complete for all of the first to sixth lower-level ECUs 14 to 19. Specifically, the PNC setting process is executed one by one for the first to sixth lower-level ECUs 14 to 19 in turn. Upon determining that the PNC setting process is not complete for all of the first to sixth lower-level ECUs 14 to 19, the higher-level ECU 10 proceeds to step S180 to switch over the process target lower-level ECU. Then, in step S160, the higher-level ECU 10 executes the PNC setting process for the process target lower-level ECU. Upon determining that the PNC setting process is complete for all of the first to sixth lower-level ECUs 14 to 19, the higher-level ECU 10 proceeds to step S190.

In step S190, the higher-level ECU 10 executes a PNC setting completion process because the PNC setting process for all lower-level ECUs 14 to 19 is complete. The PNC setting completion process will be described in more detail later.

In step S200, the higher-level ECU 10 determines whether or not it is necessary to update the PNC setting table. For example, the higher-level ECU 10 may determine whether or not it is necessary to update the PNC setting table, according to whether or not a request to update the PNC setting table is received from the cloud server 40. Upon determining that it is necessary to update the PNC setting table, the higher-level ECU 10 proceeds to step S210. Upon determining that it is unnecessary to update the PNC setting table, the higher-level ECU 10 proceeds to step S220.

In step S210, the higher-level ECU 10 executes a table update process of updating the PNC setting table that links the first to sixth lower-level ECUs 14 to 19 and their respective PNC setting information. The table update process will be described in more detail below.

In step S220, the higher-level ECU 10 determines whether or not all of the ECUs belonging to the vehicle network system 100 have transitioned to the sleep mode. This determination may be made based on whether or not a given time has elapsed since the NM messages from all of the other ECUs were not received by the higher-level ECU 10. Upon elapse of the given time since the NM messages from all of the other ECUs were absent and determining that all of the ECUs have transitioned to the sleep mode, the higher-level ECU 10 proceeds to step S230. Upon determining that not all of the ECUs have transitioned to the sleep mode, the higher-level ECU 10 returns to the process of step S140.

In step S230, the higher-level ECU 10 determines whether or not the power is turned off. Upon determining that the power is turned off, the higher-level ECU 10 ends the main process routine shown in the flowchart in FIG. 4. Upon determining that the power is not turned off, the higher-level ECU 10 returns to the process of step S110.

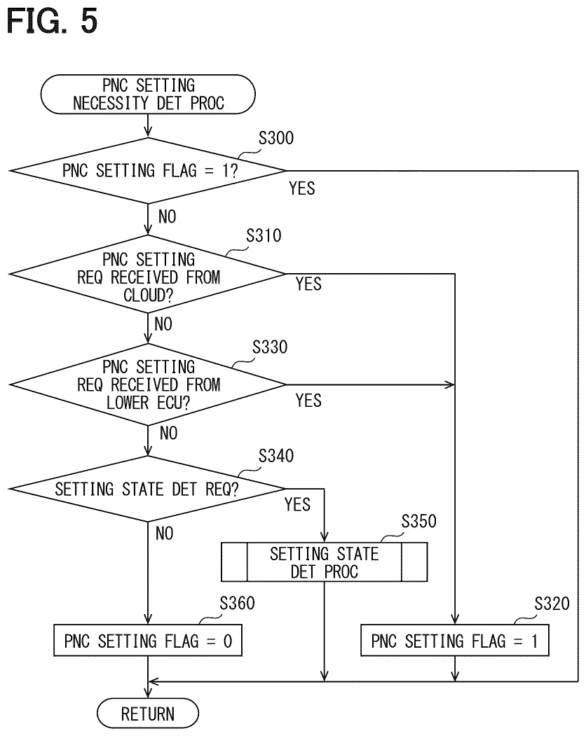

Next, the PNC setting necessity determination process in step S140 of the flowchart in FIG. 4, which is one of the subroutines of the main process routine in FIG. 4, will be described in detail. FIG. 5 is a flowchart showing an example of the details of the PNC setting necessity determination process.

In step S300, the higher-level ECU 10 determines whether or not the PNC setting flag is set to “1”. Step S320 described below sets the PNC setting flag to “1” when it is necessary to reconfigure the PNC setting information of the first to sixth lower-level ECUs 14 to 19. When it is determined in step S300 that the PNC setting flag is “1”, it is highly likely that the PNC setting process (step S160 in FIG. 4) and/or the PNC setting completion process (step S190 in FIG. 4) is not successfully complete. Therefore, if it is determined the PNC setting flag is “1” in step S300, the higher-level ECU 10 ends the PNC setting necessity determination process shown in the flowchart in FIG. 5 without changing the value of the PNC setting flag, in order to execute the PNC setting process again. Upon determining that the PNC setting flag is not “1”, the higher-level ECU 10 proceeds to step S310.

In step S310, the higher-level ECU 10 determines whether or not the higher-level ECU 10 has received the PNC setting request from the cloud server 40. Upon determining that the PNC setting request has been received from the cloud server 40, the higher-level ECU 10 proceeds to step S320 to set the PNC setting flag to “1”. As described, upon receipt of the PNC setting request from an external device such as the cloud server 40, the higher-level ECU 10 determines based on the PNC setting information that it is necessary to reconfigure the PNC setting information of the first to sixth lower-level ECUs 14 to 19. Thereafter, the higher-level ECU 10 ends the PNC setting necessity determination process shown in the flowchart in FIG. 5. Upon determining that the PNC setting request has not been received from the cloud server 40, the higher-level ECU 10 proceeds to step S330.

For example, the cloud server 40 prepares a corrected (changed) PNC setting table so that, for example, when an additional application is downloaded to a first to sixth lower-level ECU 14 to 19, this download destination lower-level ECU wakes up as the function of the additional application is required. When the corrected (changed) PNC setting table is prepared, the cloud server 40 transmits a PNC setting table update request to the higher-level ECU 10. When the PNC setting table retained by the higher-level ECU 10 is updated in response to this PNC setting table update request, the cloud server 40 may transmit the PNC setting request to the higher-level ECU 10.

Alternatively, when the PNC setting table is updated in the higher-level ECU 10, the higher-level ECU 10 may set the PNC setting flag to “1” regardless of the request from the cloud server 40. The cloud server 40 may transmit the PNC setting request at any time other than when the PNC setting table is changed. Furthermore, the cloud server 40 may prepare a corrected (changed) PNC setting table when a lower-level ECU is replaced or added, or when the software of a lower-level ECU is upgraded to have a new function. A device other than the cloud server 40, for example, the tool device described above, may transmit the PNC setting request and the PNC setting table update request to the higher-level ECU 10.

In step S330, the higher-level ECU 10 determines whether or not the higher-level ECU 10 has received the PNC setting request message from at least one lower-level ECU 14 to 19. As described later in details, a respective first to sixth lower-level ECU 14 to 19 determines whether or not the PNC setting information thereof is appropriate, and transmits the PNC setting request message to the higher-level ECU 10 upon determining that the PNC setting information is not appropriate. Upon determining that the PNC setting request message has been received from at least one lower-level ECU 14 to 19, the higher-level ECU 10 proceeds to step S320 to set the PNC setting flag to “1”. Thereafter, the higher-level ECU 10 ends the PNC setting necessity determination process shown in the flowchart in FIG. 5. Upon determining that the PNC setting request message has not been received from at least one lower-level ECU 14 to 19, the higher-level ECU 10 proceeds to step S340.

In step S340, the higher-level ECU 10 determines whether or not a setting status determination request has occurred, which is a request to determine whether or not the PNC setting information of each lower-level ECU 14 to 19 in the PNC setting table retained by the higher-level ECU 10 matches the PNC setting information configured in each lower-level ECUs 14 to 19. For example, whether the setting status determination is enabled or disabled in the higher-level ECU 10 may be configured (set) in advance by a manufacture, a seller, or a user of the vehicle network system 100. When the setting status determination is enabled, the higher-level ECU 10 executes the determination process shown in step S340 and the setting status determination process shown in step S350 periodically or in given timing. When the setting status determination is enabled, for example, the cloud server 40 or a data device may, periodically or in a given timing, generate the setting status determination request and transmit the setting status determination request to the higher-level ECU 10. The higher-level ECU 10 may execute the setting status determination process in response to receiving the setting status determination request.

Upon determining in step S340 that the setting status determination request has occurred, the higher-level ECU 10 proceeds to step S350 to execute the setting status determination process. Thereafter, the higher-level ECU 10 ends the PNC setting necessity determination process shown in the flowchart in FIG. 5. The setting status determination process will be described in detail later. Upon determining in step S340 that the setting status determination request has not occurred, the higher-level ECU 10 proceeds to step S360. In step S360, the higher-level ECU 10 sets the PNC setting flag to “0” because it is not necessary to reconfigure the PNC setting information. Thereafter, the higher-level ECU 10 ends the PNC setting necessity determination process shown in the flowchart in FIG. 5.

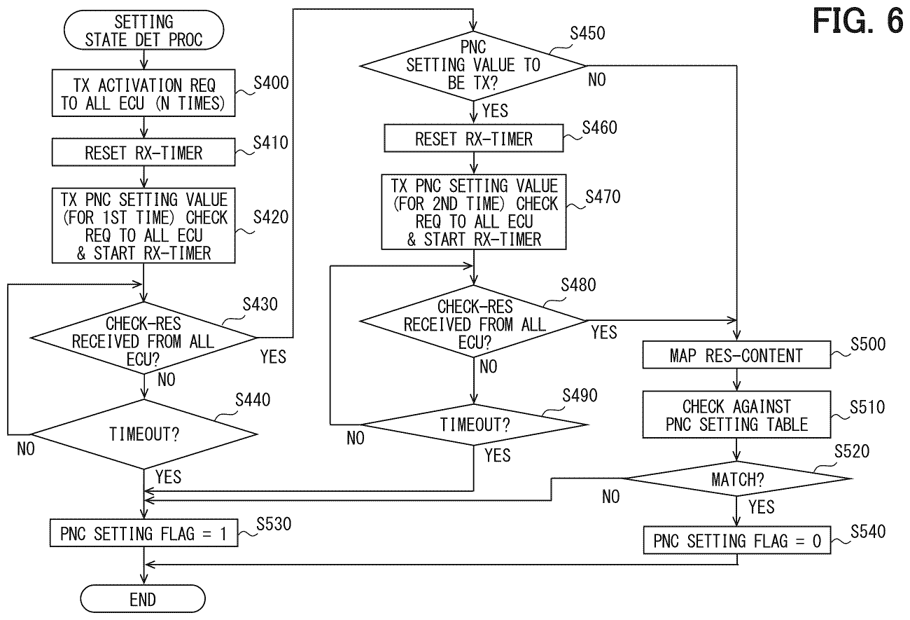

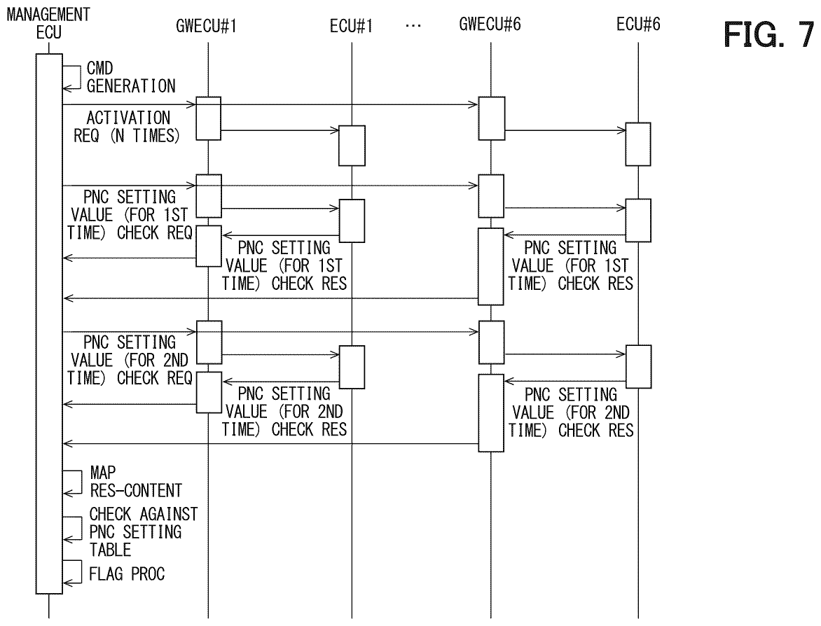

Next, the setting status determination process in step S350 of the flowchart in FIG. 5 will be described in detail. FIG. 6 is a flowchart showing an example of the details of the setting status determination process. FIG. 7 is a sequence diagram showing an example of the flow of processes in the higher-level ECU 10 and in the first to sixth lower-level ECUs 14 to 19 when the setting status determination process is executed.

In the setting status determination process, the higher-level ECU 10 first transmits the NM message N times (N is an integer of 2 or more) as the activation request in step S400, as shown in the sequence diagram in FIG. 7, wherein the NM message can wake up all of the lower-level ECUs 14 to 19. For example, as the NM message that can wake up all of the lower-level ECUs 14 to 19, the higher-level ECU 10 may transmit the NM message that includes the PN request information in which the active clusters are clusters to which all of the lower-level ECUs 14 to 19 respectively belong. Alternatively, the higher-level ECU 10 may transmit the NM message including a command instructing all lower-level ECUs 14 to 19 to wake up. By transmitting the NM message multiple times, the higher-level ECU 10 can reliably wake up all of the lower-level ECUs 14 to 19.

In step S410, the higher-level ECU 10 resets a reception timer. This reception timer is used to measure the time elapsed since the PNC setting value check request message was transmitted from the higher-level ECU 10. Then, in step S420, the higher-level ECU 10 transmits the PNC setting value (for the first time) check request message to all of the lower-level ECUs 14 to 19, as shown in the sequence diagram in FIG. 7. At the same time, the higher-level ECU 10 starts the reception timer for time measurement.

In step S430, the higher-level ECU 10 determines whether or not the higher-level ECU 10 has received a PNC setting value (for the first time) check response message from all of the respective lower-level ECUs 14 to 19. The PNC setting value (for the first time) check response message includes the first half of the PNC setting information that is set for the lower-level ECUs 14 to 19. Upon determining that the PNC setting value (for the first time) check response message has been received from all of the lower-level ECUs 14 to 19, the higher-level ECU 10 proceeds to step S450. Upon determining that the PNC setting value (for the first time) check response message has not yet been received from all of the lower-level ECUs 14 to 19, the higher-level ECU 10 proceeds to step S440.

In step S440, the higher-level ECU 10 determines whether or not a reception timeout period has elapsed based on the time measured by the reception timer. Upon determining that the reception timeout period has elapsed, the higher-level ECU 10 proceeds to step S530. Upon determining that the reception timeout period has not yet elapsed, the higher-level ECU 10 returns to the process in step S430.

When the activation request from the higher-level EUC 10 normally wakes up all of the lower-level ECUs 14 to 19 and all of the lower-level ECUs 14 to 19 are communicable with the higher-level ECU 10, it is expected that the PNC setting value (for the first time) check response message including the first half of the PNC setting information is transmitted from each lower-level ECUs 14 to 19 within a given time from the time when the higher-level ECU 10 transmits the PNC setting value (for the first time) check request message. In other words, if, at a time when the time measured by the reception timer since transmission of the PNC setting value (for the first time) check request message reaches the given time (corresponding to the timeout period), there is a lower-level ECU 10 from which the PNC setting value (for the first time) check response message has not been received, there is a possibility that an abnormality occurs in the lower-level ECU and the lower-level ECU is not normally woken up. Therefore, in step S530, the higher-level ECU 10 sets the PNC setting flag to “1” to reconfigure the PNC setting information of the first to sixth lower-level ECUs 14 to 19.

In step S450, the higher-level ECU 10 determines whether or not the PNC setting value to be transmitted but not transmitted yet is still present. This determination is made in view that because the number of clusters is large, the lower-level ECU 14 to 19 cannot transmit all of the PNC setting values of the PNC setting information by a single PNC setting value check response message. The higher-level ECU 10 may make the determination in step S450 based on the number of PNC setting values in the PNC setting information of the PNC setting table. Upon determined that the PNC setting value to be transmitted is still present, the higher-level ECU 10 proceeds to step S460. Upon determining that the PNC setting value to be transmitted is absent, the higher-level ECU 10 proceeds to step S500.

The flowchart in FIG. 6 shows the processes for cases where the first to sixth lower-level ECU 14 to 19 transmits all of the PNC setting values to the higher-level ECU 10 such that the PNC setting value check request message is transmitted one or two times and the PNC setting value check response message is transmitted one or two times. The sequence diagram in FIG. 7 shows an example in which the first to sixth lower-level ECU 14 to 19 transmits all of the PNC setting values to the higher-level ECU 10 such that the PNC setting value check request message is transmitted two times and the PNC setting value check response message is transmitted two times. In FIGS. 6 and 7, the PNC setting value check request message for the first time is shown as “PNC setting value (for 1st time) check req”, the PNC setting value check response message for the first time is shown as “PNC setting value (for 1st time) check res”, the PNC setting value check request message for the second time is shown as “PNC setting value (for 2nd time) check req”, the PNC setting value check response message for the second time is shown as “PNC setting value (for 2nd time) check res”. In the embodiments described below, it is assumed that all of the PNC setting values are transmitted by transmitting the PNC setting value check request message one or two times and transmitting the PNC setting value check response message one or two times. However, the PNC setting value check request message may be transmitted three or more times and the PNC setting value check response message may be transmitted three or more times, depending on the number of PNC setting values. If it is known in advance that the PNC setting values are transmittable by a single message, steps S450 to S490 of the flowchart in FIG. 6 may be omitted.

In step S460, the higher-level ECU 10 resets the reception timer. Then, in step S470, the higher-level ECU 10 transmits the PNC setting value (for the second time) check request message to all of the lower-level ECUs 14 to 19, as shown in the sequence diagram in FIG. 7. At the same time, the higher-level ECU 10 starts the reception timer for time measurement.

In step S480, the higher-level ECU 10 determines whether or not the PNC setting value (for the second time) check response message including the rest of the PNC setting values has been received from all of the lower-level ECUs 14 to 19. Upon determining that the PNC setting value (for the second time) check response message has been received from all of the lower-level ECUs 14 to 19, the higher-level ECU 10 proceeds to step S500. Upon determining that the PNC setting value (for the second time) check response message has not yet been received from all of the lower-level ECUs 14 to 19, the higher-level ECU 10 proceeds to step S490.

In step S490, the higher-level ECU 10 determines whether or not the reception timeout period has elapsed based on the time measured by the reception timer. Upon determining that the reception timeout period has elapsed, the higher-level ECU 10 proceeds to step S530 to set the PNC setting flag to “1”. Upon determining that the reception timeout period has not yet elapsed, the higher-level ECU 10 returns to the process in step S480.

In step S500, per lower-level ECU 19, the higher-level ECU 10 maps the PNC setting values included in the PNC setting value (for the first time) check response message received from the lower-level ECU 14 to 19, and, if a PNC setting value (for the second time) check response message is received, the PNC setting values included in the PNC setting value (for the second time) check response message. In step S510, the higher-level ECU 10 checks the PNC setting values mapped per lower-level ECU 14 to 19 against the PNC setting values of the corresponding lower-level ECU 14 to 19 in the PNC setting table retained by the higher-level ECU 10. This checking is performed for all the of the lower-level ECUs 14 to 19. Then, in step S520, the higher-level ECU 10 determines whether or not the matching is OK, based on the matching result in step S510. At this time, the higher-level ECU 10 determines that the matching is OK if a complete match of all of the PNC setting values is found for all of the lower-level ECUs 14 to 19. If a difference in at least one PNC setting value is found for at least one lower ECU 14 to 19, the higher-level ECU 10 determines that the matching is NG.

Upon determining in step S520 that the matching is NG, the higher-level ECU 10 proceeds to step S530 to set the PNC setting flag to “1” in order to reconfigure the PNC setting information of the first to sixth lower-level ECU 14 to 19. Upon determining that the matching is OK, the higher-level ECU 10 proceeds to step S540 to set the PNC setting flag to “0” because it is unnecessary to reconfigure the PNC setting information of the first to sixth lower-level ECU 14 to 19.

Via the setting status determination process described above, it is possible to update the PNC setting values in each of the lower-level ECUs 14 to 19 to match the PNC setting values in the PNC setting table of the higher-level ECU 10, even in a case where, for some reasons, the PNC setting values in the PNC setting information of the lower-level ECU 14 to 19 have become mismatched with the PNC setting values in the PNC setting information of the PNC setting table retained by the higher-level ECU 10. Accordingly, it is possible to maintain the PNC setting values, the PNC setting information, of each of the lower-level ECUs 14 to 19 appropriately.

In the above example, the higher-level ECU 10 transmits the PNC setting value check request message to all of the lower-level ECUs 14 to 19 at once. Alternatively, in a given order, the higher-level ECU 10 may transmit the PNC setting value check request messages to the respective lower-level ECUs 14 to 19 and receive the PNC setting value check response messages from the respective lower-level ECUs 14 to 19.

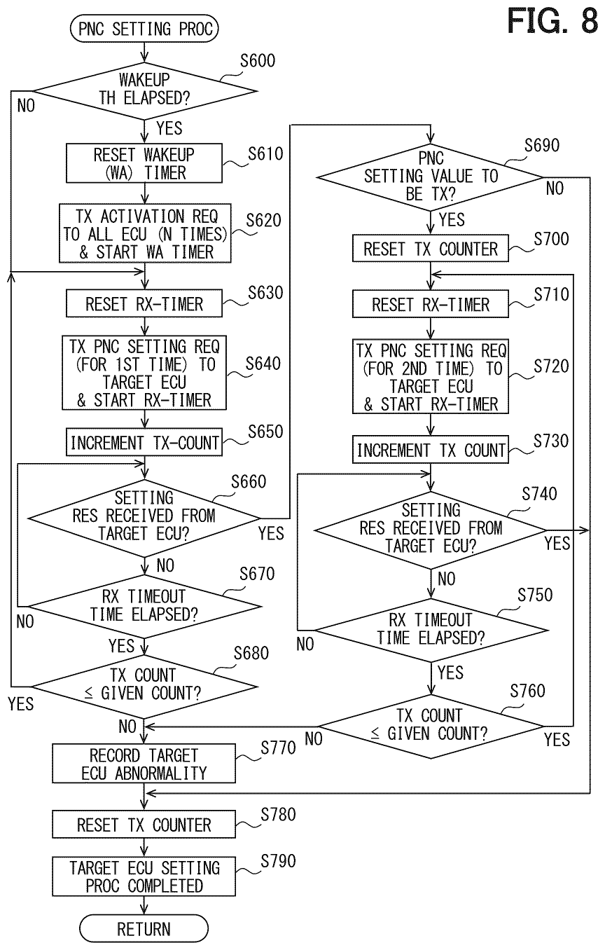

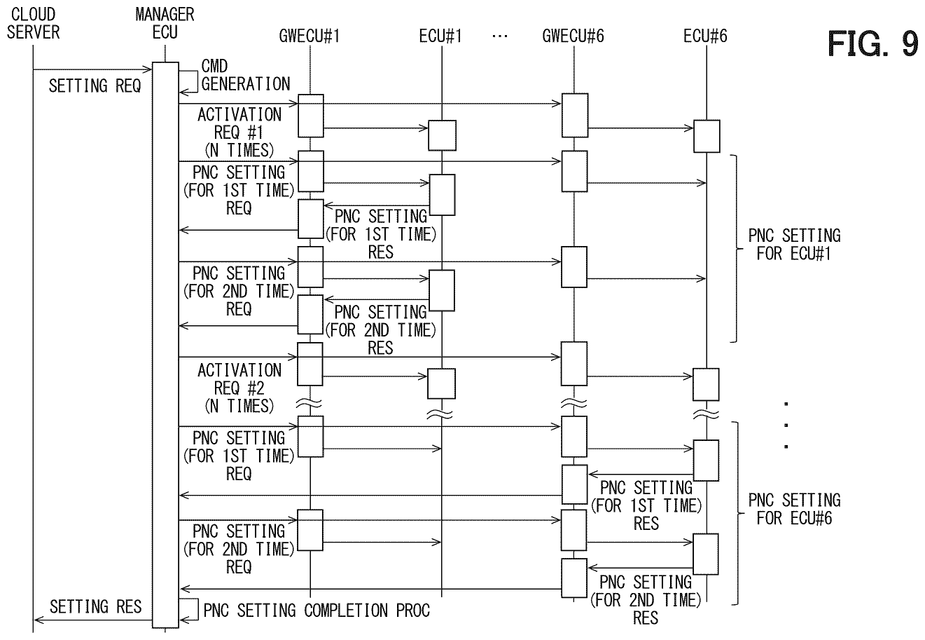

Next, the PNC setting process in step S160 of the flowchart in FIG. 4, which is one of the subroutines of the main process routine in FIG. 4, will be described in detail. FIG. 8 is a flowchart showing an example of the details of the PNC setting process. FIG. 9 is a sequence diagram showing an example of the flow of processes in the higher-level ECU 10 and in the first to sixth lower-level ECUs 14 to 19 when the PNC setting process is executed. The sequence diagram in FIG. 9 shows an example where the PNC setting process is executed in response to the PNC setting request from the cloud server 40.

The PNC setting process is executed for the first to sixth lower-level ECUs 14 to 19 in the given order. It is therefore necessary for a respective first to sixth lower-level ECU 14 to 19 to keep the wakeup mode until a turn to perform the PNC setting process. In view of this, in step S600, the higher-level ECU 10 determines based on the time measured by a wakeup (WA) timer whether or not a given wakeup threshold time has elapsed since the last time the NM message for waking up all of the lower-level ECUs 14 to 19 was transmitted N times (N is an integer greater than or equal to 2). This WA timer measures a time elapsed since the higher-level ECU 10 transmitted the NM message (activation request) for waking up all of the lower-level ECUs 14 to 19. Upon determining that the given wakeup threshold time has elapsed, the higher-level ECU 10 proceeds to step S610. Upon determining that the given wakeup threshold time has not elapsed, the higher-level ECU 10 proceeds to step S630.

In step S610, the higher-level ECU 10 resets the WA timer. Then, in step S620, the higher-level ECU 10 transmits the NM message (activation request) for waking up all of the lower-level ECUs 14 to 19, as shown in the sequence diagram in FIG. 9. At the same time, the higher-level ECU 10 starts the WA timer for time measurement.

As described above, each lower-level ECU 14 to 19 transitions to the sleep mode upon elapse of a given sleep threshold time during which neither the NM message including the PN request information in which the cluster to which the lower-level ECU belongs is designated as the active cluster nor the NM messages including the command that instructs all of the lower-level ECUs 14 to 19 to wake up is received (upon elapse of the given sleep threshold time since the last time the NM message was received). The given wakeup threshold time is set shorter than the given sleep threshold time of each lower-level ECU 14 to 19. Therefore, it is possible that before the elapse of the sleep threshold time, the higher-level ECU 10 transmits the activation request to all of the lower-level ECUs 14 to 19 according to the elapse of the wakeup threshold time. As a result, it is possible to maintain each lower-level ECUs 14 to 19 in the wakeup mode until the turn to perform the PNC setting process comes.

In step S630, the higher-level ECU 10 resets the reception timer. This reception timer is used to measure the time elapsed since the PNC setting (for the first time) request message was transmitted from the higher-level ECU 10. Then, in step S640, the higher-level ECU 10 transmits the PNC setting (for the first time) request message toward the lower-level ECU that is the target of the PNC setting process, as shown in the sequence diagram in FIG. 9. This PNC setting (for the first time) request message includes the PNC setting values of the first half of the PNC setting information linked to the PNC setting process target lower-level ECU in the updated PNC setting table. At the same time, the higher-level ECU 10 starts the reception timer for time measurement.

In step S650, the higher-level ECU 10 increments a transmission time counter by 1, wherein the transmission time counter counts the number of times the PNC setting (for the first time) request message is transmitted. In step S660, the higher-level ECU 10 determines whether or not the higher-level ECU 10 has received the PNC setting (for the first time) response message from the lower-level ECU that is the target of the PNC setting process. When the lower-level ECU being the target of the PNC setting process receives the PNC setting (for the first time) request message including the PNC setting values of the first half of the PNC setting information from the higher-level ECU 10 and stores the PNC setting values of the first half of the PNC setting information in the volatile memory 25 thereof, the lower-level ECU transmits the PNC setting (for the first time) response message. Upon determining that the PNC setting (for the first time) response message is received from the lower-level ECU being the target of the PNC setting process, the higher-level ECU 10 proceeds to step S690. Upon determining that the PNC setting (for the first time) response message has not been received from the lower-level ECU being the target of the PNC setting process, the higher-level ECU 10 proceeds to step S670.

In step S670, the higher-level ECU 10 determines whether or not the reception timeout period has elapsed, based on the time measured by the reception timer. Upon determining that the reception timeout period has elapsed, the higher-level ECU 10 proceeds to step S680. Upon determining that the reception timeout period has not yet elapsed, the higher-level ECU 10 returns to the process in step S660. Because of this, the higher-level ECU 10 can proceed with the PNC setting process even if, for some reasons, the higher-level ECU 10 fails to receive the PNC setting (for the first time) response message from the lower-level ECU being the target of the PNC setting process.

In step S680, the higher-level ECU 10 determines whether or not the number of times the PNC setting (for the first time) request message has been transmitted is less than or equal to the given number of times, based on the value of the transmission count counter. The given number of times is determinable to be any lager than one. Upon determining that the number of times the PNC setting (for the first time) request message has been transmitted is still less than or equal to the given number of times, the higher-level ECU 10 returns to the process in step S630 and repeats transmitting the PNC setting (for the first time) request message. Upon determining that the number of times the PNC setting (for the first time) request message has been transmitted exceeds the given number of times, the higher-level ECU 10 proceeds to step S770. In this way, by the higher-level ECU 10 repeating transmission of the PNC setting (for the first time) request message multiple times, it is possible to increase the probability that the PNC setting process target lower-level ECU receives the PNC setting (for the first time) request message.

In step S770, the higher-level ECU 10 records a PNC setting abnormality of the lower-level ECU being the target of the PNC setting process in the non-volatile storage medium, because the higher-level ECU 10 fails to receive the PNC setting (for the first time) response message from the lower-level ECU being the target of the PNC setting process despite repeatedly transmitting the PNC setting (for the first time) request message multiple times.

In step S690, the higher-level ECU 10 determines whether or not there is still the PNC setting value to be transmitted but not transmitted yet, in view of a large number of clusters. Upon determining that there is still the PNC setting value to be transmitted, the higher-level ECU 10 proceeds to step S700. Upon determining that the PNC setting value to be transmitted but not transmitted yet is absent, the higher-level ECU 10 proceeds to step S780.

In step S700, the higher-level ECU 10 resets the transmission count counter. In step S710, the higher-level ECU resets the reception timer. Then, in step S720, the higher-level ECU 10 transmits the PNC setting (for the second time) request message to the lower-level ECU being the PNC setting process target, as shown in the sequence diagram in FIG. 9. The PNC setting (for the second time) request message includes the PNC setting values of the latter half of the PNC setting information linked to the lower-level ECU being the PNC setting process target in the updated PNC setting table. At the same time, the higher-level ECU 10 starts the reception timer for time measurement.

In step S730, the higher-level ECU 10 increments the transmission count counter by 1. In step S740, the higher-level ECU 10 determines whether or not the higher-level ECU 10 has received the PNC setting (for the second time) response message from the lower-level ECU being the PNC setting process target. When the lower-level ECU being the PNC setting process target receives the PNC setting (for the second time) request message including the PNC setting values of the latter half of the PNC setting information from the higher-level ECU 10 and stores the PNC setting values of the latter half of the PNC setting information in the volatile memory 25 thereof, the lower-level ECU transmits the PNC setting (for the second time) response message. Upon determining that the PNC setting (for the second time) response message has been received from the lower-level ECU being the PNC setting process target, the higher-level ECU 10 proceeds to step S780. Upon determining that the PNC setting (for the second time) response message has not been received from the lower-level ECU being the PNC setting process target, the higher-level ECU 10 proceeds to step S750.

In step S750, the higher-level ECU 10 determines whether or not the reception timeout period has elapsed, based on the time measured by the reception timer. Upon determining that the reception timeout period has elapsed, the higher-level ECU 10 proceeds to step S760. Upon determining that the reception timeout period has not yet elapsed, the higher-level ECU 10 returns to the process in step S740.

In step S760, the higher-level ECU 10 determines whether or not the number of times the PNC setting (for the second time) request message has been transmitted is less than or equal to the given number of times, based on the value of the transmission count counter. Upon determining that the number of times the PNC setting (for the second time) request message has been transmitted is still less than or equal to the given number of times, the higher-level ECU 10 returns to the process in step S710 and repeats transmitting the PNC setting (for the second time) request message. Upon determining that the number of times the PNC setting (for the second time) request message has been transmitted exceeds the given number of times, the higher-level ECU 10 proceeds to step S770 to record the PNC setting abnormality of the lower-level ECU being the PNC setting process target in the non-volatile storage medium.

In step S780, the higher-level ECU 10 resets the transmission count counter, as preparation for the PNC setting process for the next lower-level ECU being the next PNC setting process target. Then, in step S790, the higher-level ECU 10 determines that the PNC setting process for the lower-level ECU being the PNC setting process target is complete, and returns to the process in the flowchart in FIG. 4. The PNC setting process shown in the flowchart in FIG. 8 is repeatedly executed until the PNC setting process is completed for all of the lower-level ECUs 14 to 19.

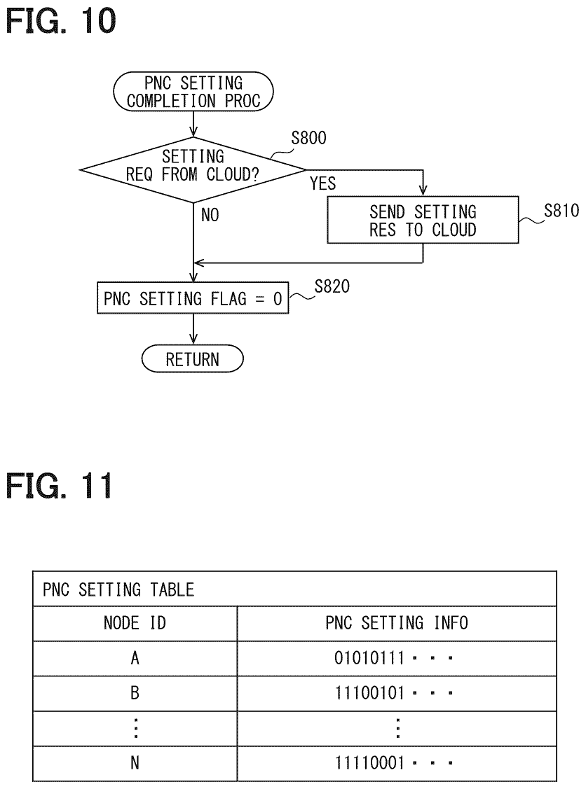

Next, the PNC setting completion process in step S190 of the flowchart in FIG. 4, which is one of the subroutines of the main process routine in FIG. 4, will be described in detail. FIG. 10 is a flowchart showing an example of details of the PNC setting completion process.

In step S800, the higher-level ECU 10 determines whether or not the PNC setting process described above has been executed in response to the PNC setting request from the cloud server 40. Upon determining that the PNC setting process has been executed in response to the PNC setting request from the cloud server 40, the higher-level ECU 10 proceeds to step S810. Upon determining that the PNC setting process has not been executed in response to the PNC setting request from the cloud server 40, the higher-level ECU 10 proceeds to step S820.

In step S810, the higher-level ECU 10 transmits the PNC setting response to the cloud server 40 indicating that the execution of the PNC setting process is complete, as shown in the sequence diagram in FIG. 9. In step S820, the higher-level ECU 10 sets the PNC setting flag to “0” in order to indicate that reconfiguring of the PNC setting information is unnecessary. The higher-level ECU 10 then returns to the process shown in the flowchart in FIG. 4.

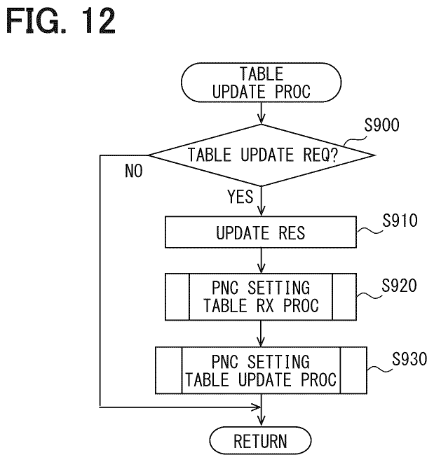

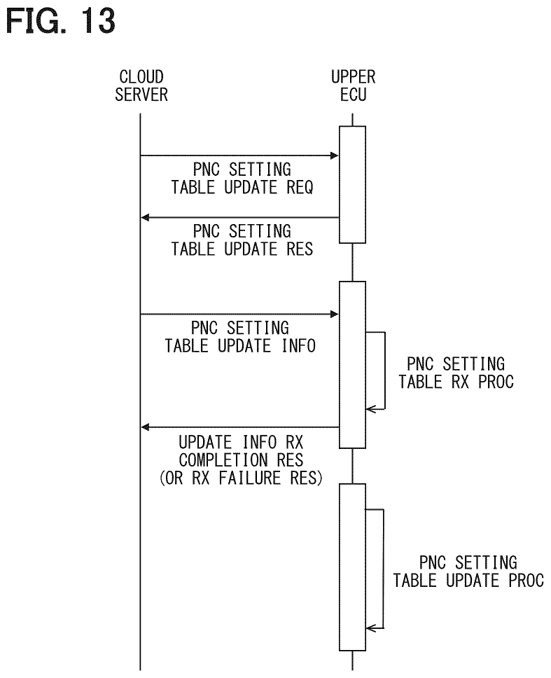

Next, the table update process in step S210 of the flowchart in FIG. 4, which is one of the subroutines of the main process routine in FIG. 4, will be described in detail. FIG. 11 shows an example of the PNC setting table. FIG. 12 is a flowchart showing an example of the details of the table update process. FIG. 13 is a sequence diagram showing an example of the process flow in the higher-level ECU 10 when the table update process is executed. The sequence diagram in FIG. 13 shows an example where the higher-level ECU 10 updates the PNC setting table through interaction with the cloud server 40.

First, the PNC setting table will be described with reference to FIG. 11. The PNC setting table is retained by the higher-level ECU 10. More specifically, the PNC setting table is stored in the non-volatile memory 10c of the higher-level ECU 10. As shown in FIG. 11, the PNC setting table is a list data that links the PNC setting information of each lower-level ECU to the corresponding node ID. The node ID is an identifier unique to each lower-level ECU 14 to 19.

The higher-level ECU 10 may retain multiple PNC setting tables of multiple types. From among the multiple PNC setting tables, the higher-level ECU 10 may select one PNC setting table to use, according to, for example, place of destination of the vehicle, grade of the vehicle, option equipped to the vehicle or the like. Specifically, from among the multiple PNC setting tables, one PNC setting table to be enabled is selected and enabled. In this case, the higher-level ECU 10 by itself may select one PNC setting table according to destination of the vehicle, grade of the vehicle or the like. The higher-level ECU 10 may select one PNC setting table following instructions from an external device such as the cloud server 40. When place of use of the vehicle or option information is changed, the higher-level ECU 10 may switch over the PNC setting table to use so that the PNC setting table is used according to the place of use of the vehicle or the option information.

From an external device such as the cloud server 40, the higher-level ECU 10 may receive multiple PNC setting tables of multiple types that are highly likely used, so that the multiple PNC setting tables are retained by the higher-level ECU 10. In this case, the external device such as the cloud server 40 may issue instructions to the higher-level ECU 10 as to one PNC setting table to be used (to be enabled), according to type of ECUs actually mounted on the vehicle. function provided by these ECUs, or the like.

The PNC setting tables of multiple types retained by the higher-level ECU 10 may include, for example, a PNC setting table for vehicle evacuation traveling in addition to a PNC setting table customized by a user. The PNC setting table for evacuation traveling includes the PNC setting information of ECUs that is configured so that, for example, only ECUs involved in a function for vehicle traveling are woken up and the other ECUs are kept sleep. This makes it easier for the vehicle to travel a longer distance in the evacuation traveling. The higher-level ECU 10 may switch over to the PNC setting table for evacuation traveling in response to such a necessity arising that because of occurrence of a significant abnormality in the vehicle, it is necessary for the vehicle to travel into a safe area by the evacuation traveling.

When the PNC setting table to use among the PNC setting tables of multiple types is switched over in the higher-level ECU 10, the higher-level ECU 10 executes the PNC setting process described above. Accordingly, the PNC setting information retained by the first to sixth lower ECUs 14 to 19 is changed based on the switched over PNC setting table.

Next, the table update process will be described with reference to FIG. 12. In step S900, the higher-level ECU 10 determines whether or not the higher-level ECU 10 has received the PNC setting table update request from the cloud server 40, as shown in the sequence diagram in FIG. 13. For example, in a case of addition or replacement of the first to sixth lower-level ECU 14 to 19 or addition of an application, the cloud server 40 may prepare the PNC setting table that includes the post-change PNC setting information. When the cloud server 40 prepares the PNC setting table including the post-change PNC setting information, the cloud server 40 transmits the PNC setting table update request to the higher-level ECU 10. Upon determining that the PNC setting table update request has been received, the higher-level ECU 10 proceeds to step S910. Upon determining that the PNC setting table update request has not been received, the higher-level ECU 10 ends the table update process shown in the flowchart in FIG. 12.

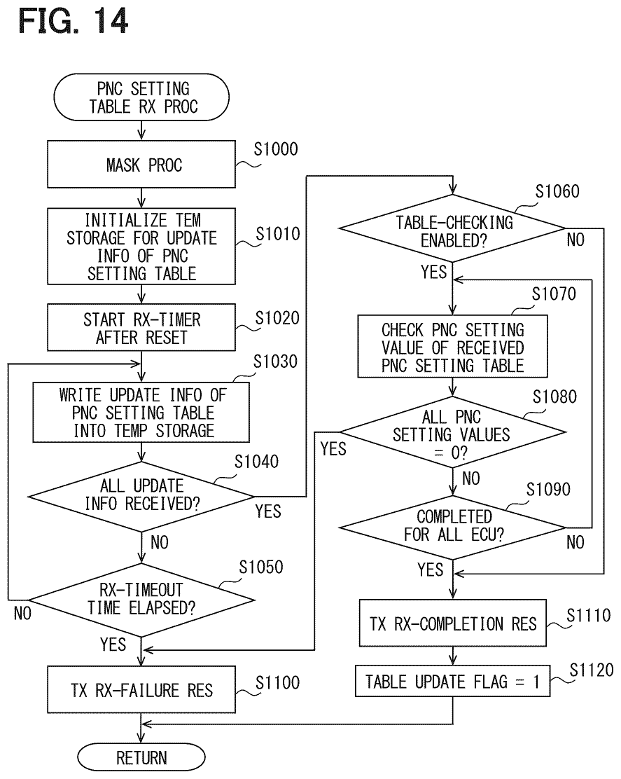

In step S910, the higher-level ECU 10 transmits a PNC setting table update response to the cloud server 40, as shown in the sequence diagram in FIG. 13. In response to this PNC setting table update response, the cloud server 40 transmits the PNC setting table including the updated PNC setting information to the higher-level ECU 10 as the PNC setting table update information (corresponding to cluster setting information for update also called for-update cluster setting information of the present disclosure). At step S920, the higher-level ECU 10 executes the PNC setting table receiving process to receive the PNC setting table update information. Next, an example of the PNC setting table receiving process will be described with reference to the flowchart in FIG. 14.

In step S1000, the higher-level ECU 10 executes a mask process for preventing overwriting the current PNC setting table stored in the non-volatile storage medium 10c of the higher-level ECU 10. In this mask process, the higher-level ECU 10 performs mask so that the storage area of the non-volatile storage medium 10c storing the current PNC setting table is not rewritable when receiving the PNC setting table update information and storing the PNC setting table. This makes it possible to prevent the current PNC setting table from being accidentally overwritten with the PNC setting table in the received PNC setting table update information.

Assume that the current PNC setting table is directly overwritten with the PNC setting table in the received PNC setting table update information. In this case, if the reception of the PNC setting table update information is cut off for some reasons, the PNC setting values of the PNC setting table in the PNC setting table update information and the PNC setting values in the current PNC setting table may coexist, causing an unintended PNC setting table. In view of this, in the present embodiment, the higher-level ECU 10 temporarily saves the PNC setting table of the received PNC setting table update information in a storage area (temporary storage) separate from the storage area of the current PNC setting table. This temporary storage may be a storage area of the non-volatile memory 10c but preferably a storage area of the volatile memory 10b being a storage medium separate from the non-volatile memory 10c. This is because use of the storage area of the volatile memory 10b as the temporary storage can reduce the number of rewrites of the non-volatile memory 10c. In step S1010, the higher-level ECU 10 initializes the storage area being the temporary storage of the PNC setting table in the PNC setting table update information.

In step S1020, the higher-level ECU 10 resets and thereafter starts the reception timer that measures the reception time of the PNC setting table update information. In step S1030, the higher-level ECU 10 writes the PNC setting table of the received PNC setting table update information into the temporary storage. In step S1040, the higher-level ECU 10 determines whether or not all PNC setting table update information has been received. This determination may be based, for example, on whether or not data indicating the end of the PNC setting table update information has been received. Upon determining that all PNC setting table update information has not yet been received, the higher-level ECU 10 proceeds to step S1050. Upon determined that all PNC setting table update information has been received, the higher-level ECU 10 proceeds to step S1060.

In step S1050, the higher-level ECU 10 determines whether or not the reception timeout period has elapsed based on the time measured by the reception timer. The reception timeout period is determined as a period of time longer than a period of time for the higher-level ECU 10 to receive the PNC setting table update information from the cloud server 40 in cases of no abnormality. Therefore, upon determining in step S1050 that the reception timeout period has elapsed, the higher-level ECU 10 returns to the process in step S1100, and as shown in the sequence diagram in FIG. 13, the higher-level ECU 10 transmits a reception failure response to the cloud server 40 indicating that the receiving of the PNC setting table update information failed.

This reception failure response also includes an indication to the cloud server 40 that the PNC setting table update information is requested to be transmitted again. Upon receipt of the reception failure response from the higher-level ECU 10, the cloud server 40 transmits again the PNC setting table update information to the higher-level ECU 10. When transmitting the reception failure response, the higher-level ECU 10 discards the incomplete PNC setting table update information stored in the temporal storage.

After executing the process of step S1100, the higher-level ECU 10 once ends the PNC setting table receiving process shown in the flowchart of FIG. 14. Upon determining in step S1050 that the reception timeout period has not yet elapsed, the higher-level ECU 10 returns to the process in step S1030.

In step S1060, the higher-level ECU 10 determines whether or not the check function of the PNC setting table is enabled. Whether the check function of the PNC setting table is enabled or disabled in the higher-level ECU 10 may be configured in advance by, for example, a manufacturer, a seller, or a user of the vehicle network system 100. Upon determining that the check function of the PNC setting table is enabled, the higher-level ECU 10 proceeds to step S1070. Upon determining that the check function of the PNC setting table is disabled, the higher-level ECU 10 proceeds to step S1110.

In step S1070, per lower-level ECU 14 to 19, the higher-level ECU 10 checks the PNC setting values of the PNC setting information linked to the lower-level ECU in the PNC setting table of the received PNC setting table update information. Then, in step S1080, the higher-level ECU 10 determines whether or not all of the PNC setting values of the PNC setting information linked to the check target lower-level ECU are “0” or not. When all of the PNC setting values are “0”, this means that the check target lower-level ECU does not belong to any cluster. In this case, the check target lower-level ECU cannot be woken up by the NM message including the PN request information designating the active cluster. For this reason, it is not supposed to happen that the correct PNC setting table update information is successfully received at the higher-level ECU 10 and all of the PNC setting values for any one or more of the lower-level ECUs 14 to 19 are “0”. In other words, when all of the PNC setting values of the PNC setting information linked to a certain lower-level ECU are “0”, this indicates that an abnormality has occurred in the reception of the PNC setting table update information. Therefore, upon determining that all of the PNC setting values of the PNC setting information linked to the check target lower-level ECU are “0,” the higher-level ECU 10 proceeds to step S1100 and transmits the reception failure response to the cloud server 40 indicating that the reception of the PNC setting table update information failed. Upon determining that not all of the PNC setting values of the PNC setting information of the check target lower-level ECU are “0”, the higher-level ECU 10 proceeds to step S1090.

As described, when the setting of the PNC setting information in the PNC setting table of the PNC setting table update information is such that at least one lower-level ECU 14 to 19 does not belong to any cluster, the higher-level ECU 10 transmits the reception failure response to the cloud server 40 and thereby requests the cloud server 40 to transmit the PNC setting table update information again. Furthermore, the higher-level ECU 10 discards the PNC setting table update information in which the setting of the PNC setting information is such that at least one lower-level ECU 14 to 19 does not belong to any cluster.

In step S1090, the higher-level ECU 10 determines whether or not the check of the PNC setting values of the PNC setting information for all the lower-level ECUs 14 to 19 is complete. Upon determining that the check of the PNC setting values of the PNC setting information of all the lower-level ECUs 14 to 19 is complete, the higher-level ECU 10 proceeds to step S1110. Upon determining that the check of the PNC setting values of the PNC setting information of all of the lower-level ECUs 14 to 19 is not complete, the higher-level ECU 10 returns to the process of step S1070.

In step S1110, the higher-level ECU 10 transmits a reception completion response to the cloud server 40 indicating that the reception of the PNC setting table update information is complete, as shown in the sequence diagram in FIG. 13. In step S1120, the higher-level ECU 10 sets the value of the table update flag to “1” indicating that it is necessary to update the table, and ends the PNC setting table receiving process shown in the flowchart in FIG. 14.

As described above, the higher-level ECU 10 sets the table update flag to “1” upon normally receiving the PNC setting table update information and storing it in the temporal storage. The table update flag of “1” indicates that it is necessary to update the PNC setting table. Therefore, the higher-level ECU 10 performs the PNC setting table update process described below to update the PNC setting table stored in the non-volatile memory 10c by using the PNC setting table in the received PNC setting table update information. If the received PNC setting table update information is incomplete or has such setting of the PNC setting information that at least one lower-level ECU 14 to 19 does not belong to any cluster, the higher-level ECU 10 does not set the table update flag to “1”. Therefore, updating the PNC setting table stored in the non-volatile memory 10c based on the PNC setting table in the PNC setting table update information is not executed. This makes it possible to prevent the inappropriate update of the PNC setting table stored in the non-volatile memory 10c.

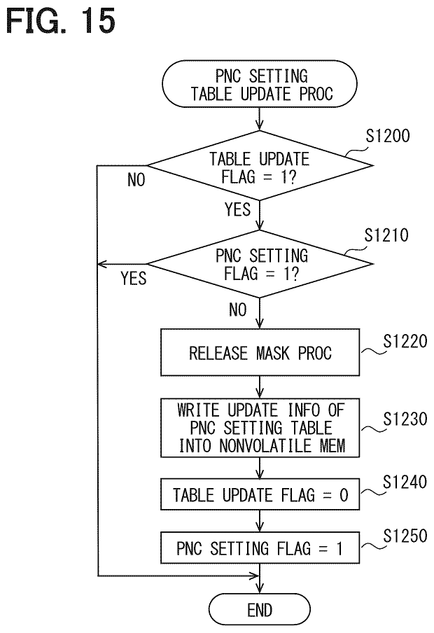

As shown in the flowchart in FIG. 12 and the sequence diagram in FIG. 13, after ending the PNC setting table receiving process, the higher-level ECU 10 next executes the PNC setting table update process in step S930. FIG. 15 is a flowchart showing an example of the details of the PNC setting table update process. The PNC setting table update process will be described below with reference to the flowchart in FIG. 15.

In step S1200, the higher-level ECU 10 determines whether or not the value of the table update flag is set to “1” indicating that it is necessary to update the PNC setting table. Upon determining that the value of the table update flag is set to “1”, the higher-level ECU 10 proceeds to step S1210. Upon determining that the value of the table update flag is not set to “1”, the higher-level ECU 10 ends the PNC table update process shown in the flowchart in FIG. 15.

In step S1210, the higher-level ECU 10 determines whether or not the value of the PNC setting flag is set to “1”. When the value of the PNC setting flag is set to “1”, this indicates to the lower-level ECUs 14 to 19 that it is necessary to update the PNC setting information. Therefore, there is a possibility that the higher-level ECU 10 is executing the PNC setting process for the lower-level ECUs 14 to 19 based on the PNC setting table stored in the non-volatile memory 10c. Under this circumstance, if the PNC setting table is updated, the PNC configuration process may be executed with co-existence of the old and new PNC setting tables. Therefore, upon determining in step S1210 that the value of the PNC setting flag is set to “1”, the higher-level ECU 10 ends the PNC setting table update process shown in the flowchart in FIG. 15. Upon determining in step S1210 that the value of the PNC setting flag is not set to “1”, the higher-level ECU 10 proceeds to step S1220.

In step S1220, the higher-level ECU 10 releases the mask process on the current PNC setting table stored in the non-volatile memory 10c. In other words, provided that the value of the PNC setting flag is set to “0”, the higher-level ECU 10 releases the mask process on the current PNC setting table. Therefore, the mask process on the current PNC setting table stored in the non-volatile memory 10c is maintained as long as the PNC setting flag is “1”, specifically while the higher-level ECU 10 is configuring (changing) the setting of the PNC setting information of the first to sixth lower-level ECUs 14 to 19 based on the PNC setting table stored in the non-volatile memory 10c.

In step S1230, the higher-level ECU 10 updates the PNC setting table by overwriting the current PNC setting table stored in the non-volatile memory 10c with the PNC setting table of the PNC setting table update information stored in the temporal storage. In the above, the higher-level ECU 10 may write the PNC setting table of the PNC setting table update information into a storage area separate from the storage area of the non-volatile memory 10c storing the current PNC setting table. In this case, it is necessary for the higher-level ECU 10 to identify which PNC setting table is the latest.

In step S1240, the higher-level ECU 10 sets the value of the table update flag to “0” because updating the PNC setting table is complete. In step S1250, the higher-level ECU 10 sets the value of the table update flag to “1”. This step is provided in view that because the PNC setting table is updated, it is necessary to reconfigure the PNC setting information of the first to sixth lower-level ECUs 14 to 19 based on the updated PNC setting table. As described, in response to updating the PNC setting table, the present embodiment changes the PNC setting information of the first to sixth lower-level ECUs 14 to 19 based on the updated PNC setting table. Thereafter, the higher-level ECU 10 ends the PNC setting table update process shown in the flowchart of FIG. 15.

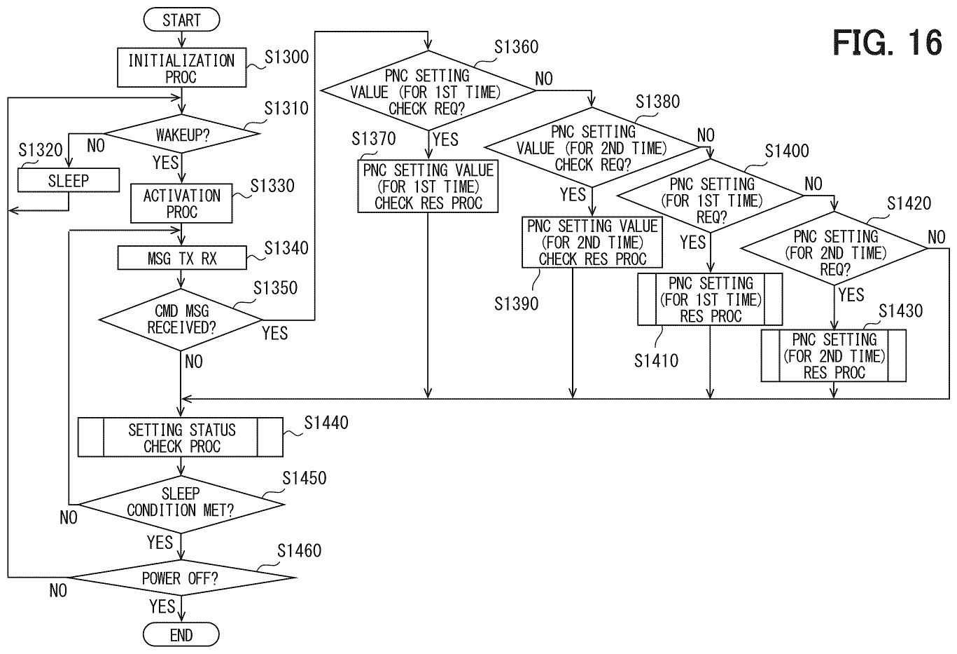

Next, various processes executed in the first to sixth lower-level ECUs 14 to 19 regarding network management will be described with reference to the flowcharts of FIG. 16 to 19. The first to sixth lower-level ECUs 14 to 19 individually execute the processes described below.

The flowchart in FIG. 16 shows an example of the main process routine executed in each of the first to sixth lower-level ECUs 14 to 19. The main process routine executed in the first lower-level ECU 14 will be described below as a representative example. When power is turned on, the first lower-level ECU 14 starts the main process routine shown in the flowchart in FIG. 16.

In step S1300, the first lower-level ECU 14 executes an initialization process. The initialization process includes, for example, hardware initial setting and storage medium operation checking. In step S1310, the first lower-level ECU 14 determines whether or not a wakeup factor for the first lower-level ECU 14 has occurred. For example, the first lower-level ECU 14 may determine that the wakeup factor has occurred, upon: input of a signal indicative of necessity to wake up (trigger signal, switch signal, sensor signal, etc.); receipt of the NM message including the PN request information designating the cluster to which the first lower-level ECU 14 belongs as the active cluster; or receipt of the NM message including the command that instructs all the lower-level ECUs 14 to 19 to wake up. Upon determining in step S1310 that the wakeup factor has not occurred, the first lower-level ECU 14 proceeds to step S1320 to transition to the sleep mode. Upon determining that the wakeup factor has occurred, the first lower-level ECU 14 proceeds to step S1330.

In step S1330, the first lower-level ECU 14 executes the activation process. The activation process includes, for example, reading software including an operating system (OS) and a program from the storage and storing the read software in the memory. In step S1340, while executing the given process, the first lower-level ECU 14 periodically transmits the NM message including the active-cluster information that designates the cluster to which the first lower-level ECU 14 belongs as the active cluster. In step S1340, the first lower-level ECU 14 also executes reception of messages including the NM message transmitted from other ECUs including the higher-level ECU 10 and various command messages transmitted from the higher-level ECU 10.

In step S1350, the first lower-level ECU 14 determines whether or not the first lower-level ECU 14 has received the command message from the higher-level ECU 10. Examples of the command message include, at least, the PNC setting value (for the first time) check request message, the PNC setting value (for the second time) check request message, the PNC setting (for the first time) request message, and the PNC setting (for the second time) request message. Upon determining that the command message has been received, the first lower-level ECU 14 proceeds to step S1360. Upon determining that the command message has not been received, the first lower-level ECU 14 proceeds to step S1440.

In step S1360, the first lower-level ECU 14 determines whether or not the received command message is the PNC setting value (for the first time) check request message. Upon determining that the received command message is the PNC setting value (for the first time) check request message, the first lower-level ECU 14 proceeds to step S1370. Upon determining that the received command message is not the PNC setting value (for the first time) check request message, the first lower-level ECU 14 proceeds to step S1380.

In step S1370, the first lower-level ECU 14 executes the PNC setting value (for the first time) check response process. Specifically, the first lower-level ECU 14 generates the PNC setting value (for the first time) check response message including the first half of the PNC setting values of the PNC setting information thereof (i.e., the PNC setting information that is set for the first lower-level ECU 14) and transmits the PNC setting value (for the first time) check response message to the higher-level ECU 10. Thereafter, the first lower-level ECU 14 proceeds to step S1440.

In step S1380, the first lower-level ECU 14 determines whether or not the received command message is the PNC setting value (for the second time) check request message. Upon determining that the received command message is the PNC setting value (for the second time) check request message, the first lower-level ECU 14 proceeds to step S1390. Upon determining that the received command message is not the PNC setting value (for the second time) check request message, the first lower-level ECU 14 proceeds to step S1400.

In step S1390, the first lower-level ECU 14 executes the PNC setting value (for the second time) check response process. Specifically, the first lower-level ECU 14 generates the PNC setting value (for the second time) check response message including the latter half of the PNC setting values of the PNC setting information thereof and transmits the PNC setting value (for the second time) check response message to the higher-level ECU 10. Thereafter, the first lower-level ECU 14 proceeds to step S1440.

In step S1400, the first lower-level ECU 14 determines whether or not the received command message is the PNC setting (for the first time) request message. Upon determining that the received command message is the PNC setting (for the first time) request message, the first lower-level ECU 14 proceeds to step S1410. Upon determining that the received command message is not the PNC setting (for the first time) request message, the first lower-level ECU 14 proceeds to step S1420.

In step S1410, the first lower-level ECU 14 executes the PNC setting (for the first time) response process. The PNC setting (for the first time) response process will be described in detail later. Thereafter, the first lower-level ECU 14 proceeds to step S1440.

In step S1420, the first lower-level ECU 14 determines whether or not the received command message is the PNC setting (for the second time) request message. Upon determining that the received command message is the PNC setting (for the second time) request message, the first lower-level ECU 14 proceeds to step S1430. Upon determining that the received command message is not the PNC setting (for the second time) request message, the first lower-level ECU 14 proceeds to step S1440.

In step S1430, the first lower-level ECU 14 executes the PNC setting (for the second time) response process. The PNC setting (for the second time) response process will be described in detail later. Thereafter, the first lower-level ECU 14 proceeds to step S1440.

In step S1440, the first lower-level ECU 14 executes a setting status check process for checking whether or not the PNC setting values of the PNC setting information thereof are appropriate. This setting status check process will be described in detail later. The setting status check process may be performed after the PNC setting information has been changed by the higher-level ECU 10. For example, the setting status check process may be executed after the elapse of a certain time since the PNC setting (for the first time) request message was received from the higher-level ECU 10, wherein the certain time is a time required for the first lower-level ECU 14 to complete the PNC setting based also on the receipt of the PNC setting (for the second time) request message. Alternatively, the setting status check process may be performed in response to determination that a condition for transition to the sleep mode is met in step S1450 described below.

In step S1450, the first lower-level ECU 14 determines whether or not the condition for transition to the sleep mode is met. For example, when the first lower-level ECU 14 transitions to the wakeup mode, the first lower-level ECU 14 executes the given process assigned to the first lower-level ECU 14. When the execution of this given process is ended and the time during which the NM message including the PN request information in which the cluster to which the first lower-level ECU 14 belongs is designated as the active cluster is not received reaches the given time, the first lower-level ECU 14 may determine that the condition for transition to the sleep mode is met. Upon determining that the condition for transition to the sleep mode is met, the first lower-level ECU 14 proceeds to step S1460. Upon determining that the condition for transition to the sleep mode is not met, the first lower-level ECU 14 returns to the process of step S1340.

In step S1460, the first lower-level ECU 14 determines whether or not the power is turned off. Upon determining that the power is turned off, the first lower-level ECU 14 ends the main process routine shown in the flowchart in FIG. 16. Upon determining that the power is not turned off, the first lower-level ECU 14 returns to the process of step S1310.

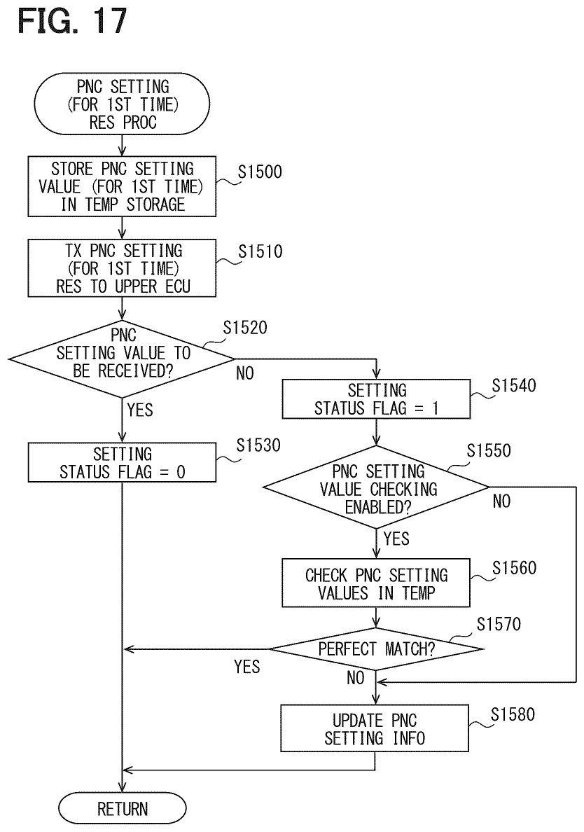

Next, the PNC setting (for the first time) response process in step S1410 of the flowchart in FIG. 16, which is one of the subroutines of the main process routine in FIG. 16, will be described in detail. FIG. 17 is a flowchart showing an example of the details of the PNC setting (for the first time) response process.

In step S1500, into the volatile memory 25 being the temporary storage, the first lower-level ECU 14 saves the PNC setting information for the first time (i.e., the first half of the PNC setting values of the PNC setting information (for the first time)) included in the received PNC setting (for the first time) request message. In step S1510, the first lower-level ECU 14 transmits the PNC setting (for the first time) response message to the higher-level ECU 10. When the higher-level ECU 10 receives this PNC setting (for the first time) response message, the higher-level ECU 10 then transmits the PNC setting (for the second time) request message including the PNC setting values for the second time (i.e., the latter half of the PNC setting values) to the first lower-level ECU 14.

In step S1520, the first lower-level ECU 14 determines whether or not the PNC setting value to be received from but not yet received from the higher-level ECU 10 is present. For example, in a case where the higher-level ECU 10 cannot transmit all the PNC setting values by a single message because of a large number of clusters, the first lower-level ECU 14 may determine that the PNC setting value to be received is still present. Upon determining that the PNC setting value to be received is still present, the first lower-level ECU 14 proceeds to step S1530. Upon determining that the PNC setting value to be received is not present, the first lower-level ECU 14 proceeds to step S1540.

In step S1530, the first lower-level ECU 14 sets the value of the setting status flag to “0”. The “0” of the setting status flag indicates that the change of the PNC setting information is not yet complete because the latter half of the PNC setting values of the PNC setting information have not yet been received, i.e., not all of the PNC setting values necessary for changing the PNC setting information have been received. Thereafter, the first lower-level ECU 14 ends the PNC (for the first time) response process shown in the flowchart in FIG. 17.

In step S1540, the first lower-level ECU 14 sets the value of the setting status flag to “1”. The “1” of the configuration status flag indicates the state in which the PNC setting information change is completable because all the PNC setting values necessary for changing the PNC setting information have been received.

In step S1550, the first lower-level ECU 14 determines whether or not the matching of the PNC setting values is enabled. Whether the matching of the PNC setting values is enabled or disabled in the first lower-level ECU 14 may be configured in advance by, for example, a manufacturer, a seller, or a user of the vehicle network system 100. Upon determining that the matching of the PNC setting values is enabled, the first lower-level ECU 14 proceeds to step S1560. Upon determining that the matching of the PNC setting values is disabled, the first lower-level ECU 14 proceeds to step S1580.

In step S1560, the first lower-level ECU 14 checks whether or not there is a perfect match between the PNC setting values of the PNC setting information stored in the volatile memory 25 being the temporary storage and the PNC setting values of the current PNC setting information stored in the non-volatile memory 26. Then, in step S1570, the first lower-level ECU 14 determines whether or not the matching result is the perfect match between both. Upon determining the perfect match, the first lower-level ECU 14 ends the PNC setting (for the first time) response process shown in the flowchart in FIG. 17. Specifically, in the case of the perfect match, the process of updating the PNC setting information by writing the PNC setting information stored in the volatile memory 25 into the non-volatile memory 26 is not executed by first lower-level ECU 14. This can reduce the number of rewrites of the non-volatile memory 26. Upon determining that the result is not the perfect match, the first lower-level ECU 14 proceeds to step S1580.

In step S1580, the first lower-level ECU 14 executes the process of updating the PNC setting information by writing the PNC setting information stored in the volatile memory 25 into the non-volatile memory 26. Thereafter, the first lower-level ECU 14 ends the PNC (for the first time) response process shown in the flowchart in FIG. 17.

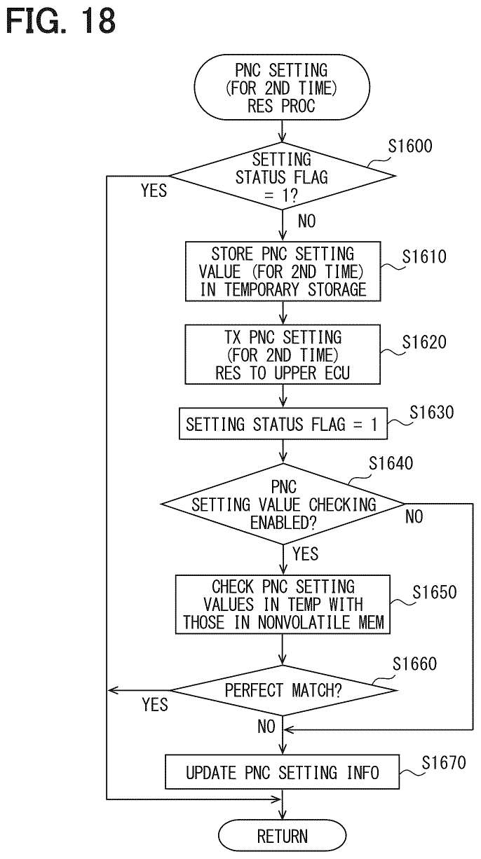

Next, the PNC setting (for the second time) response process in step S1430 of the flowchart in FIG. 16, which is one of the subroutines of the main process routine in FIG. 16, will be described in detail. FIG. 18 is a flowchart showing the details of the PNC setting (for the second time) response process.

In step S1600, the first lower-level ECU 14 determines whether or not the value of the setting status flag is set to “1”. Upon determining that the value of the setting status flag is set to “1”, the first lower-level ECU 14 ends the PNC setting (for the second time) response process shown in the flowchart in FIG. 18 because it is unnecessary to respond to the PNC setting (for the second time) request message. Upon determining that the value of the setting status flag is not set to “1”, the first lower-level ECU 14 proceeds to step S1610.

In step S1610, into the volatile memory 25 being the temporary storage, the first lower-level ECU 14 saves the PNC setting information for the second time (i.e., the latter half of the PNC setting values of the PNC setting information) included in the received PNC setting (for the second time) request message. In step S1620, the first lower-level ECU 14 transmits a PNC setting (for the second time) response message to the higher-level ECU 10. When the higher-level ECU 10 receives this PNC setting (for the second time) response message, the higher-level ECU 10 switches over the lower-level ECU being the target of the PNC setting process, as shown in the sequence diagram in FIG. 9. Then, after receiving the PNC setting (for the second time) response message from all the lower-level ECUs 14 to 19, the PNC setting completion process is executed.

In step S1630, the first lower-level ECU 14 sets the value of the setting status flag to “1”. This is based on that because of the receipt of the PNC setting information for the second time, the first lower-level ECU 14 has already received all of the PNC setting values necessary for changing the PNC setting information and is in the state in which the PNC setting information change is completable.

In step S1640, the first lower-level ECU 14 determines whether or not the matching of the PNC setting values is enabled. Upon determining that the matching of the PNC setting values is enabled, the first lower-level ECU 14 proceeds to step S1650. Upon determining that the matching of the PNC setting values is disabled, the first lower-level ECU 14 proceeds to step S1670.

In step S1650, the first lower-level ECU 14 checks whether or not there is a perfect match between the PNC setting values of the PNC setting information stored in the volatile memory 25 being the temporary storage and the PNC setting values of the current PNC setting information stored in the non-volatile memory 26. Then, in step S1660, the first lower-level ECU 14 determines whether or not the matching result is the perfect match between both. Upon determining the perfect match, the first lower-level ECU 14 ends the PNC setting (for the second time) response process shown in the flowchart in FIG. 18. Upon determining that the result is not the perfect match, the first lower-level ECU 14 proceeds to step S1670.

In step S1670, the first lower-level ECU 14 executes the process of updating the PNC setting information by writing the PNC setting information for the first and second times stored in the volatile memory 25 into the non-volatile memory 26. Thereafter, the first lower-level ECU 14 ends the PNC (for the second time) response process shown in the flowchart in FIG. 18.

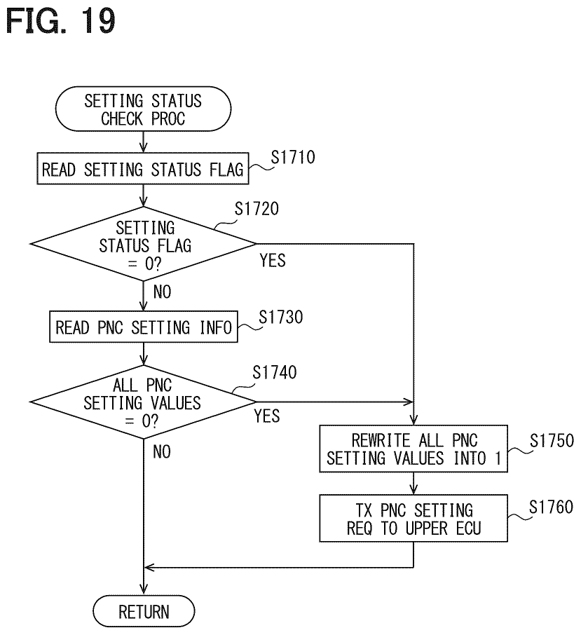

Next, the setting status check process in step S1440 of the flowchart in FIG. 16, which is one of the subroutines of the main process routine in FIG. 16, will be described in detail. FIG. 19 is a flowchart showing an example of the details of the setting status check process.

In step S1710, the first lower-level ECU 14 references to the value of the setting status flag. Then, in step S1720, the first lower-level ECU 14 determines whether or not the value of the setting status flag is “0”. For example, when the value of the setting status flag is “0” after elapse of a certain time since the PNC setting (for the first time) request message was received from the higher-level ECU 10, this indicates that not all of the PNC setting values necessary for changing the PNC setting information has been received, wherein the certain time is a time required for the first lower-level ECU 14 to complete the PNC setting based also on the receipt of the PNC setting (for the second time) request message. In this case, it is possible to consider that the PNC setting (PNC configuring) has not been performed and the PNC setting values are not appropriate. Therefore, upon determining in step S1720 that the value of the setting status flag is “0”, the first lower-level ECU 14 proceeds to step S1750. Upon determining that the value of the setting status flag is not “0”, the first lower-level ECU 14 proceeds to step S1730.

In step S1730, the first lower-level ECU 14 references to the PNC setting information thereof. Then, in step S1740, the first lower-level ECU 14 determines whether or not all of the PNC setting values in the PNC setting information are “0”. When all of the PNC setting values are “0”, this indicates that the first lower-level ECU 14 does not belong to any cluster. In this case, the first lower-level ECU 14 cannot be woken up by the NM message including the PN request information designating the active cluster. For this reason, the PNC setting values that are all “0” cannot be considered appropriate. Therefore, upon determining in step S1740 that all of the PNC setting values are “0”, the first lower-level ECU 14 proceeds to step S1750. Upon determining that not all of the PNC setting values are “0”, the first lower-level ECU 14 ends the setting status check process shown in the flowchart in FIG. 19 and returns to the process in the flowchart in FIG. 16.

In step S1750, the first lower-level ECU 14 rewrites all the PNC setting values in the PNC setting information thereof into “1”. Specifically, upon determining that the PNC setting information that is set for the first lower-level ECU 14 is not appropriate, the first lower-level ECU 14 changes the PNC setting information thereof so that the first lower-level ECU 14 belongs to all the clusters. This changes the activation condition so that the first lower-level ECU 14 is woken up by any NM message including the PN request information that designates at least one cluster as the active cluster. Accordingly, it is possible to prevent an occurrence of a situation where the first lower-level ECU 14 cannot be activated by the NM message.

In step S1760, the first lower-level ECU 14 transmits the PNC setting request message to the higher-level ECU 10. As mentioned above, when the first lower-level ECU 14 changes the activation condition, the first lower-level ECU 14 is woken up by any NM message. In this case, the first lower-level ECU 14 wakes up at a time when the first lower-level ECU 14 is not supposed to wake up. By transmitting the PNC setting request message by the first lower-level ECU 14, it is possible for the higher-level ECU 10 to reconfigure the PNC setting information of the first lower-level ECU 14 into the appropriate PNC setting information. As a result, the power consumption due to unnecessary wakeup of the first lower-level ECU 14 can be reduced.

### MODIFICATIONS

Preferred embodiments of the present disclosure have been described above. The present disclosure is not limited to the above-described embodiments, and can be implemented by various modifications without departing from the spirit and scope of the present disclosure.

### First Modification

In the above embodiments, when the PNC setting information is not appropriate, the first to sixth lower-level ECU 14 to 19 performs the rewrite of all the PNC setting values of the configured PNC setting information into “1” as the change in the activation condition by the activation condition changer unit 27. However, the change in the activation condition is not limited to the rewrite of the PNC setting values.

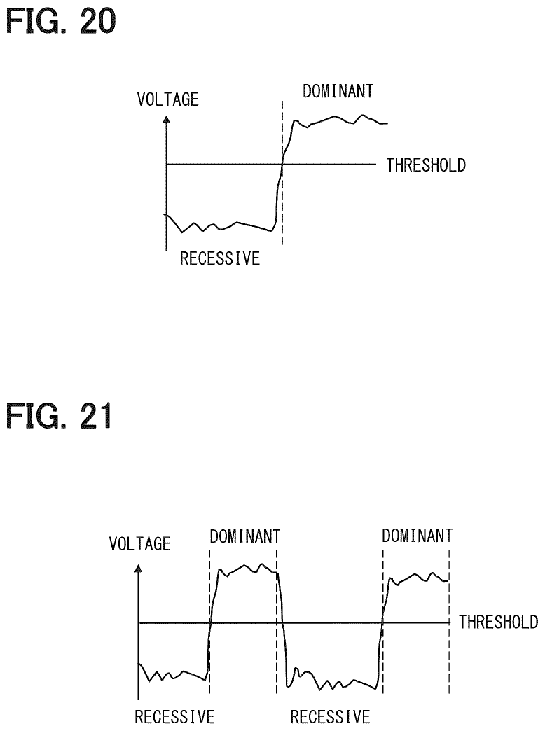

For example, upon determining that the PNC setting information is not appropriate, the activation condition changer unit 27 of the first to sixth lower-level ECU 14 to 19 may change the activation condition so that the first to sixth lower-level ECU 14 to 19 wakes up in response to the received message having a given signal level. Specifically, as shown in FIG. 20, the activation condition changer unit 27 may change the activation condition so that the first to sixth lower-level ECU 14 to 19 wakes up in response to the communication IF detecting that the level of the message transmitted and received via the communication bus 20 to 22 has become dominant. Because the message always includes a dominant level signal, it is possible to change the activation condition so that the first to sixth lower-level ECU 14 to 19 wakes up in response to any message.

Alternatively, upon determining that the PNC setting information is not appropriate, the activation condition changer unit 27 may change the activation condition so that the first to sixth lower-level ECU 14 to 19 wakes up in response to the message having a given signal pattern. Specifically, as shown in FIG. 21, the activation condition may be changed so that the first to sixth lower-level ECU 14 to 19 wakes up in response to the communication IF detecting a change from recessive to dominant twice in a row, which is a signal pattern always included in the message transmitted and received via the communication bus 20 to 22. In the case of the above change in the activation condition also, it is possible to wake up the first to sixth ECU by any message.

### Second Modification

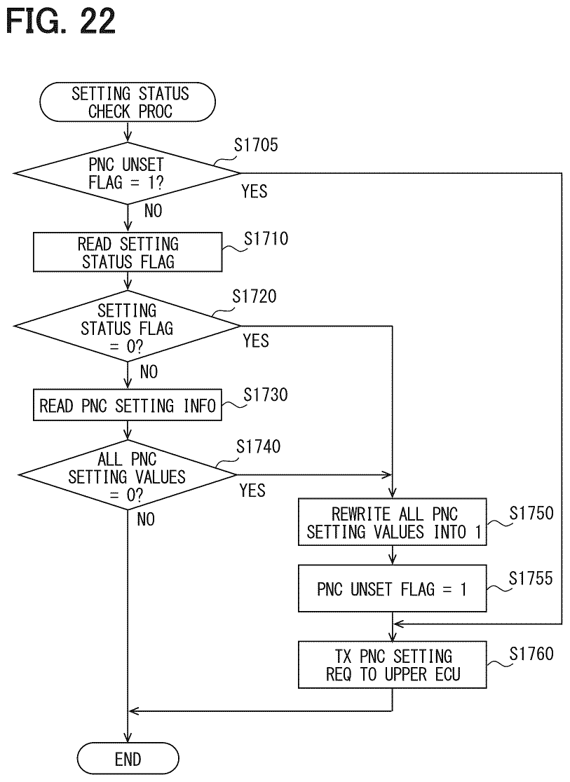

The setting status check process shown in the flowchart in FIG. 19 may be modified into that shown in the flowchart in FIG. 22. The setting status check process shown in the flowchart in FIG. 22 further includes steps S1705 and S1755 as compared with the setting status check process shown in the flowchart in FIG. 19.

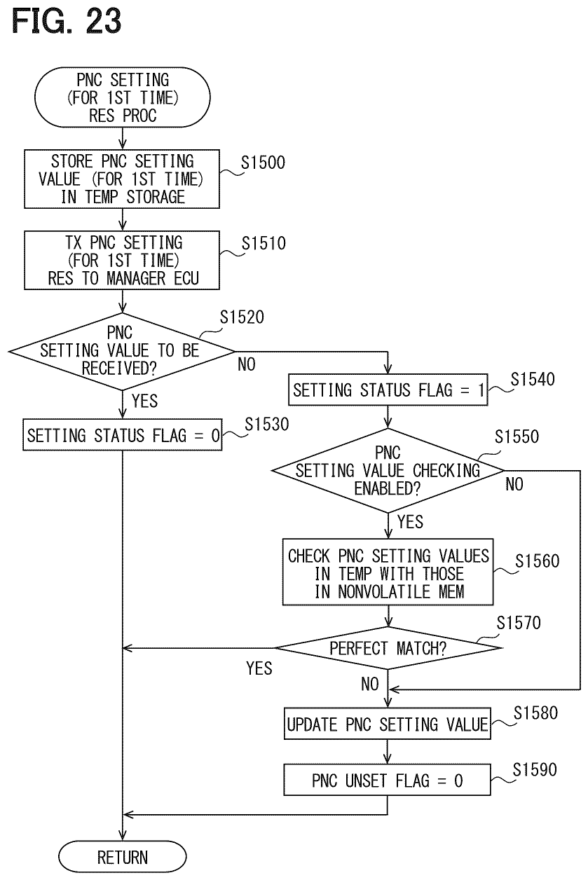

Step S1705 determines whether or not a value of a PNC not-set flag is “1”. Step S1755 sets the PNC not-set flag to “1”. Specifically, Step S1755 sets the PNC not-set flag to “1” upon step S1750 rewriting all the PNC setting values into “1”. Step S1590 sets the PNC not-set flag to “0” in response to writing the PNC setting values stored in the temporary storage into the non-volatile memory 26 so that all the PNC setting values rewritten into “1” are updated, as shown in the flowchart of FIG. 23. Although not shown in the drawings, the PNC setting (for the second time) response process similarly includes setting the PNC not-set flag to “0” in response to updating the PNC setting values stored in the non-volatile memory 26 by using the PNC setting value saved in the temporary storage. Specifically, after the activation condition has been changed, setting the PNC not-set flag to “1” is executed within a time period during which the update of the PNC setting information is not performed by the cluster manager unit 10a of the upper-level ECU 10. The PNC not-set flag becomes “0” when the update of the PNC setting information is performed by the cluster manager unit 10a.

In the present modification, as shown in the flowchart in FIG. 22, if it is determined in step S1705 that the value of the PNC not-set flag is “1”, the process jumps to step S1760 to execute the process of transmitting the PNC setting request to the higher-level ECU 10. Therefore, the first to sixth lower-level ECU 14 to 19 can repeatedly transmit the PNC setting request message until updating the PNC setting information is performed by the cluster manager unit 10a.

### Third Modification

The systems and methods thereof described in the present disclosure may be implemented by a special purpose computer that includes a processor programmed to execute one or more functions embodied by a computer program. The systems and methods described in the present disclosure may be implemented using a dedicated hardware logic circuit. The systems and methods thereof described in the present disclosure may be implemented by one or more special purpose computers configured by a combination of a processor that executes a computer program and one or more hardware logic circuits. For example, part or all of the functions provided by the higher-level ECU 10, the first to third GW ECUs 11 to 13, and the first to sixth lower-level ECUs 14 to 19 may be realized as hardware. A configuration in which a certain function is implemented by hardware logic circuitry includes a configuration in which the function is implemented using one or more ICs or the like. Part or all of the functions provided by the higher-level ECU 10, the first to third GW ECUs 11 and 13, and the first to sixth lower-level ECUs 14 to 19 may be implemented using any of a system-on-chip (SoC), an integrated circuit (IC), or a field-programmable gate array (FPGA). The concept of IC includes ASIC (Application Specific Integrated Circuits). The computer program described above may be stored in a computer-readable non-transitory tangible storage medium as instructions to be executed by a computer. A hard disk drive (i.e., HDD), a solid-state drive (i.e., SSD), a flash memory, or the like can be adopted as a storage medium storing the computer program. The present disclosure includes programs causing computers to function as the higher-level ECU 10, the first to third GW ECUs 11 to 13, and the first to sixth lower-level ECUs 14 to 19, and non-transitory tangible storage media such as semiconductor memories storing the programs.

What is claimed is:

1. A vehicle network system mounted on a vehicle, comprising
a plurality of control devices communicable with each other,
wherein the plurality of control devices each provided by at least a processor and a memory includes:
a management-target control device that retains cluster information indicative of a cluster to which the management-target control device belongs among a plurality of clusters being divisions, and that becomes an active state in response to an activation message from another control device including active-cluster information indicative of the cluster to be active that matches the cluster indicated by the cluster information; and
a manager control device that includes a storage medium storing cluster setting information for configuring the cluster information of the management-target control device and has a function of configuring the cluster information of the management-target control device based on the stored cluster setting information,
wherein:
the manager control device is capable of receiving, from an external device, for-update cluster setting information for updating the cluster setting information; and
when receiving the for-update cluster setting information, the manager control device stores the for-update cluster setting information in a storage medium separate from the storage medium storing the cluster setting information or in a storage area separate from a storage area storing the cluster setting information.

2. The vehicle network system according to claim 1, wherein
when the for-update cluster setting information is received and stored, the manager control device updates the stored cluster setting information based on the for-update cluster setting information.

3. The vehicle network system according to claim 2, wherein
in response to updating the cluster setting information, the manager control device changes the cluster information retained by the management target control device based on the updated cluster setting information.

4. The vehicle network system according to claim 2, wherein:
the manager control device verifies whether or not setting in the stored for-update cluster setting information regarding the cluster information of the management target control device is such that the management target control device belongs to at least one cluster; and
when the setting in the stored for-update cluster setting information regarding the cluster information of the management target control device is such that the management target control device does not belong to any of the clusters, the manager control device does not execute updating the stored cluster setting information based on the for-update cluster setting information.

5. The vehicle network system according to claim 4, wherein
the manager control device discards the for-update cluster setting information in which the setting regarding the cluster information of the management target control device is such that the management target control device does not belong to any of the clusters.

6. The vehicle network system according to claim 4, wherein
when the setting in the for-update cluster setting information regarding the cluster information of the management target control device is such that the management target control device does not belong to any of the clusters, the manager control device requests the external device to transmit the for-update cluster setting information again.

7. The vehicle network system according to claim 1, wherein
when receiving and storing the for-update cluster setting information, the manager control device masks a storage area storing the cluster setting information so that the storage area is not rewritable.

8. The vehicle network system according to claim 1, wherein
the manager control device masks a storage area storing the cluster setting information so that the storage area is not rewritable while changing the cluster information of the management target control device based on the cluster setting information.

9. The vehicle network system according to claim 1, wherein:
the cluster setting information of a plurality of types is storable in the manager control device; and
the external device issues instructions to the manager control device as to the cluster setting information to be enabled among the cluster setting information of the plurality of types.

10. The vehicle network system according to claim 9, wherein
when the cluster setting information enabled is changed via the instructions from the external device, the manager control device changes the cluster information retained by the management target control device based on the cluster setting information that is newly enabled.

11. The vehicle network system according to claim 1, wherein:
the cluster setting information of a plurality of types is storable in the manager control device;
the cluster setting information of the plurality of types includes cluster setting information for vehicle evacuation traveling; and
when the vehicle is required to perform evacuation traveling, the manager control device changes the cluster information retained by the management target control device based on the cluster setting information for vehicle evacuation traveling.

12. The vehicle network system according to claim 1, wherein
in the manager control device, the storage medium storing the cluster setting information is a non-volatile storage medium.

13. A control method of a vehicle network system mounted on a vehicle and including a plurality of control devices communicable with each other,
the plurality of control devices including:
a management-target control device that retains cluster information indicative of a cluster to which the management-target control device belongs among a plurality of clusters being divisions, and that becomes an active state in response to an activation message from another control device including active-cluster information indicative of the cluster to be active that matches the cluster indicated by the cluster information; and
a manager control device that includes a storage medium storing cluster setting information for configuring the cluster information of the management-target control device and has a function of configuring the cluster information of the management-target control device based on the stored cluster setting information,
the control method comprising:
the manager control device receiving, from an external device, for-update cluster setting information for updating the cluster setting information; and
when receiving the for-update cluster setting information, the manager control device storing the for-update cluster setting information in a storage medium separate from the storage medium storing the cluster setting information or in a storage area separate from a storage area storing the cluster setting information.

14. A manager control device applied to a vehicle network system that is mounted on a vehicle and includes a plurality of control devices communicable with each other,
the plurality of control devices including:
a management-target control device that retains cluster information indicative of a cluster to which the management-target control device belongs among a plurality of clusters being divisions, and that becomes an active state in response to an activation message from another control device including active-cluster information indicative of the cluster to be active that matches the cluster indicated by the cluster information; and
the manager control device that includes a storage medium storing cluster setting information for configuring the cluster information of the management-target control device and has a function of configuring the cluster information of the management-target control device based on the stored cluster setting information,
wherein:
the manager control device is capable of receiving, from an external device, for-update cluster setting information for updating the cluster setting information; and
when receiving the for-update cluster setting information, the manager control device stores the for-update cluster setting information in a storage medium separate from the storage medium storing the cluster setting information or in a storage area separate from a storage area storing the cluster setting information.
